(19) United States
(12) Patent Application Publication
(10) Pub. No.: US 2015/0269760 A1
(43) Pub. Date: Sep. 24, 2015

(54) DISPLAY CONTROL METHOD AND SYSTEM

(71) Applicant: FUJITSU LIMITED, Kawasaki-shi (JP)

(72) Inventors: IORI MURAKAMI, Yokohama (JP); SUSUMU KOGA, Kawasaki (JP)

(73) Assignee: FUJITSU LIMITED, Kawasaki-shi (JP)

(21) Appl. No.: 14/645,524

(22) Filed: Mar. 12, 2015

(30) Foreign Application Priority Data
Mar. 18, 2014 (JP) 2014-054304

(51) Int. Cl. G06T 11/60; G09G 5/00; G06T 3/40; G06T 19/00; G06T 7/00

(52) U.S. Cl. CPC G06T 11/60; G06T 19/006; G06T 7/004; G06T 3/40; G06T 7/0004; G09G 5/003; G09G 2370/02

(57) ABSTRACT

A system includes circuitry configured to acquire image data captured by an electronic device, acquire content and display position information corresponding to the content based on an object detected in the image data, the display position information indicating a display position of the content in relation to the object, determine whether the content is capable of being displayed by a display in a superimposed manner on the image data at the display position, generate guide information indicating at least one of a recommended size and a recommended position of the object in relation to the display based on at least one of a position and a size of the object in the image data when it is determined that the content is not capable of being displayed, and output the guide information.

### CROSS-REFERENCE TO RELATED APPLICATION

This application is based upon and claims the benefit of priority of the prior Japanese Patent Application No. 2014-054304, filed on Mar. 18, 2014, the entire contents of which are incorporated herein by reference.

### FIELD

The embodiments discussed herein are related to a technology that superimposedly displays image data on another image data.

### BACKGROUND

When an image, in which the real world is imaged, is displayed on a display device, an augmented reality (AR) technology is known that superimposedly displays content, which does not exist in the real world, on an image which is displayed on the display device, thereby providing a synthesized image as if the content exists in the real world. Hereinafter, the content is referred to as “AR content”. A user who reads the synthesized image may acquire information which is displayed as the AR content, and may understand more information compared to a case in which the user directly views the real world. The AR content may be image data which evokes characteristic meaning for itself according to a form, a color, or the like, or may be image data which includes text data.

The AR includes a technology called location base AR or a technology called vision-based AR. The former acquires the positional information or the direction-related information of a terminal with a camera from a GPS sensor or the like, and determines the details of the AR content to be superimposedly displayed or the position of the AR content to be superimposedly displayed according to the positional information or the direction-related information.

The latter performs object recognition or space recognition on image data acquired by the camera. Further, in the vision-based AR, when it is recognized that the acquired image includes a specific object, AR content corresponding to the specific object is superimposedly displayed according to the result of the space recognition (for example, Japanese Laid-open Patent Publication Nos. 2002-092647 and 2004-048674). When a recognition target is a marker, the AR is called marker-type vision-based AR. When a recognition target is an object other than the marker, the AR is called marker-less type vision-based AR.

In addition, a technology is known in which a selection object for menu selection is displayed on the display device of a game machine when an imaging apparatus included in the game machine, on which the vision-based AR function is mounted, captures a marker (for example, Japanese Laid-open Patent Publication No. 2012-068984). Further, when the user tilts the game machine and the optical axis of the imaging apparatus crosses the collision area of the selection object, the game machine determines that the selection object is selected.

### SUMMARY

According to an aspect of the invention, a system includes circuitry configured to acquire image data captured by an electronic device, acquire content and display position information corresponding to the content based on an object detected in the image data, the display position information indicating a display position of the content in relation to the object, determine whether the content is capable of being displayed by a display in a superimposed manner on the image data at the display position, generate guide information indicating at least one of a recommended size and a recommended position of the object in relation to the display based on at least one of a position and a size of the object in the image data when it is determined that the content is not capable of being displayed, and output the guide information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates the relationship between a camera coordinate system and a marker coordinate system;

FIG. 2 illustrates an example of AR content;

FIG. 3 illustrates a transformation matrix which converts the marker coordinate system to the camera coordinate system and a rotation matrix within the transformation matrix;

FIG. 4 illustrates rotation matrixes;

FIG. 5 is a diagram illustrating an image in a real world viewed from a certain point of view;

FIG. 6 is a diagram illustrating an image in a real world viewed from another point of view;

FIG. 7 is a diagram illustrating an AR display image based on an image which is photographed by a user;

FIG. 8 is a diagram illustrating another AR display image based on an image which is photographed by another user;

FIG. 9 is a diagram illustrating the configuration of a system;

FIG. 10 is a diagram illustrating an example of guide information;

FIG. 11 is a functional block diagram illustrating the function of a display apparatus according to a first embodiment;

FIG. 12 illustrates an example of the configuration of a data table which stores AR content information;

FIG. 13 illustrates an example of the configuration of a data table which stores template information;

FIG. 14 is a graph illustrating a guide information generation process;

FIG. 15 is a flowchart (first) illustrating a display control process according to the first embodiment;

FIG. 16 is a flowchart (second) illustrating the display control process according to the first embodiment;

FIG. 17 is a flowchart illustrating the guide information generation process;

FIG. 18 illustrates a display image of synthesized image data collectively displaying guide information and reference information;

FIG. 19 illustrates a display image of other synthesized image data collectively displaying the guide information and the reference information;

FIGS. 20A and 20B are views illustrating the display state of AR content acquired when the position on which the marker is stuck is changed;

FIG. 21 is a functional block diagram illustrating a display apparatus according to a second embodiment;

FIGS. 22A and 22B are views illustrating synthesized image data in an AR content rearrangement process;

FIG. 23 is a flowchart (first) illustrating a display control process according to the second embodiment;

FIG. 24 is a flowchart (second) illustrating the display control process according to the second embodiment;

FIG. 25 illustrates an example of the hardware configuration of the display apparatus according to each embodiment;

FIG. 26 illustrates an example of the configuration of a program which is operated by a computer; and

FIG. 27 illustrates an example of the hardware configuration of a management apparatus.

### DESCRIPTION OF EMBODIMENTS

A computer, to which a vision-based AR technology is applied, performs an object recognition process on image data. Further, when a specific object is recognized, the computer performs a display control process in order to superimposedly display AR content on the image data. In the display control process, the computer estimates the positional relationship between a recognition target and a camera through object recognition and space recognition with regard to the image data acquired by the camera. Since the AR content includes the positional relationship (arrangement position and arrangement posture) which is determined in advance while assuming the recognition target as a reference, the positional relationship between the camera and content is determined using the previously estimated positional relationship between the recognition target and the camera.

Here, in a technology according to the related art, when the display control process is performed while using an image in which a specific object is photographed as a process target, there is a case in which AR content, which is superimposedly displayed on the image corresponding to a specific object originally, is not displayed on a display device. For example, there is a system which supports a work by AR displaying AR content which expresses details of a work. A worker who uses the system recognizes the AR content, which expresses the details of the work, in a synthesized image which is displayed on the display device, and works according to the expressed details of the work. However, if the AR content is not displayed in the synthesized image which is displayed on the display device, it is difficult for the worker to acquire information of the AR content. That is, it is difficult for the worker to notice that a work expressed by the AR content has to be performed.

Here, in an aspect of the embodiment, an object of the present disclosure is to notify the existence of AR content which is not superimposedly displayed on a display device.

Hereinafter, embodiments of the present disclosure will be described in detail. It is possible to appropriately combine the respective embodiments below in a range in which pieces of process content are not contradicted with each other.

Hereinafter, a marker-type vision-based AR which uses a marker will be described as an example. However, it is possible to apply technologies disclosed in the respective embodiments to a marker-less type vision-based AR. When the marker-less type vision-based AR is used, a dictionary in which the shape of an object of a recognition target is defined is prepared in advance in the object recognition process, and the object recognition process is performed on image data using the dictionary.

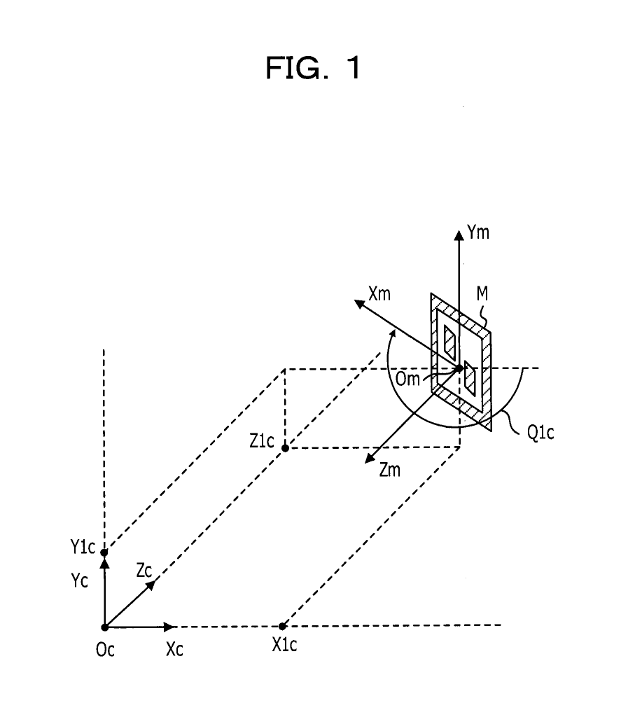

Initially, the relationship between a camera coordinate system centering on a camera and a marker coordinate system centering on a marker will be described. FIG. 1 is a diagram illustrating the relationship between the camera coordinate system and the marker coordinate system. The marker is, for example, a shape having a unique form which is printed on paper attached to the walls, ceilings, facilities, or the like in a building. Since a recognition target is a marker in the marker-type vision-based AR, the marker is recognized when image data includes specific image data indicative of the unique form or the marker.

In FIG. 1, it is assumed that the origin of the camera coordinate system is Oc(0, 0, 0). The camera coordinate system includes three dimensions of (Xc, Yc, Zc). An Xc-Yc plane surface is parallel to the surface of the imaging element of the camera. In addition, a Zc axis is perpendicular to the surface of the imaging element. The origin Oc may be an actual focus of the camera, or a position which is separated from the focus of the camera by a predetermined distance in the Zc direction may be set to the origin Oc.

Subsequently, as illustrated in FIG. 1, the origin of the marker coordinate system is Om(0, 0, 0). The origin Om is the center of a marker M. The marker coordinate system includes three dimensions of (Xm, Ym, Zm). For example, an Xm-Ym plane surface of the marker coordinate system is a surface which is parallel to the marker M, and a Zm axis is an axis which is perpendicular to the surface of the marker M. In the marker coordinate system, the size of a single marker in the image data is set to unit coordinates.

In contrast, the origin Om of the marker coordinate system is expressed as (X1c, Y1c, Z1c) in the camera coordinate system. The coordinates (X1c, Y1c, Z1c) of Om in the camera coordinate system are calculated by performing the object recognition and the space recognition on the image data acquired from the camera.

Here, in order to perform the object recognition and the space recognition, a form which is capable of distinguishing the positional relationship between the marker and the camera is used as the form of the marker. In addition, the size of the marker is determined in advance. Therefore, it is possible to recognize the marker by performing the object recognition on the image data, and it is possible to distinguish the positional relationship of the marker with regard to the camera based on the form or size of the image of the marker in the image data. For example, the marker M has the form of a square in which the length of a side is 5 cm.

In addition, the rotary angle of the marker coordinate system (Xm, Ym, Zm) with regard to the camera coordinate system (Xc, Yc, Zc) is expressed by rotary coordinates G1c (P1c, Q1c, R1c). P1c is a rotary angle around an Xc axis, Q1c is a rotary angle around a Yc axis, and R1c is a rotary angle around a Zc axis. The marker coordinate system illustrated in FIG. 1 rotates only around the Ym axis, and thus P1c and R1c are 0. Each of the rotary angles is calculated based on the comparison of the already-known marker form and a marker image form in the imaged image.

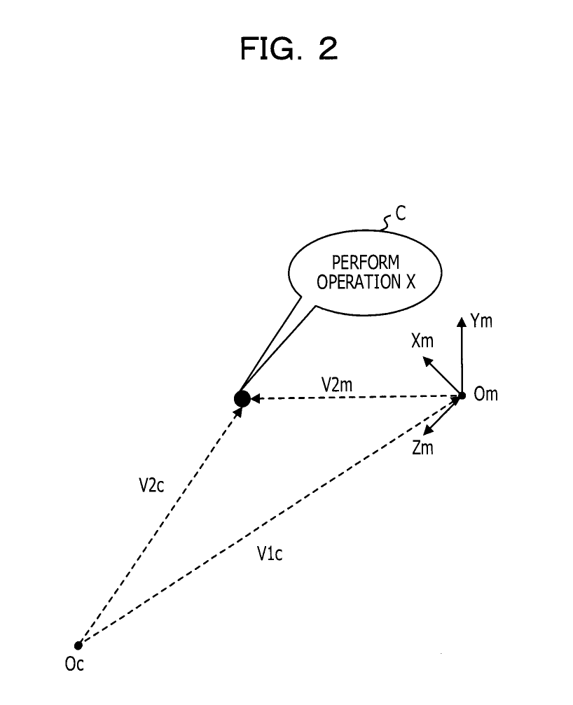

FIG. 2 illustrates an example of the AR content. AR content C illustrated in FIG. 2 is image data having a balloon form, and includes text information “perform operation X” within a balloon. Further, in the AR content C, positional information and rotary information relative to the marker are set in advance. That is, the positional information and the rotary information of the AR content in the marker coordinate system are set.

Here, the positional information and the rotary information will be described in detail. A former black dot of the AR content C in FIG. 2 is the reference point V2m(X2m, Y2m, Z2m) of the AR content C. In addition, the posture of the AR content C is prescribed by rotary coordinates G2m(P2m, Q2m, R2m), and the size of the AR content C is prescribed by a magnification D(Jx, Jy, Jz). The rotary coordinates G2m of the AR content C indicate the extent that the AR content is rotated and arranged with regard to the marker coordinate system. For example, although not similar to the example illustrated in FIG. 2, the AR content is AR displayed in parallel to the marker when G2m is (0, 0, 0).

Subsequently, the form of the AR content C is set by individually setting the coordinates of each of the points, which are included in the AR content C, in addition to the reference point. In the embodiment, the form of the AR content C will be described using a template which is prepared in advance. That is, the coordinates of each of the points which form the AR content C are defined in the template which is a model of the form of the AR content C. However, in the template, the reference point is set to coordinates (0, 0, 0), and each of the points other than the reference point is defined as a relative value with regard to the coordinates of the reference point. Therefore, when the reference point V2m of the AR content C is set, the coordinates of each of the points which form the template are shifted in parallel based on the coordinates V2m.

Further, the coordinates of each of the points which are included in the template are rotated based on the set rotary coordinates G2m, and the distance between adjacent points is extended or reduced by the magnification D. That is, the AR content C illustrated in FIG. 2 indicates a state in which each of the points in the template is formed based on a point which is adjusted based on the coordinates V2m of the reference point, the rotary coordinates G2m, and the magnification D.

As described above, the arrangement of the AR content with regard to the marker is determined based on the positional information and the rotary information of the AR content. Accordingly, when the user photographs the marker using the camera, the computer generates image data indicative of the figure of the AR content acquired when it is assumed that the camera photographs the AR content, the arrangement of which is determined relative to the marker. In a procedure in which the image data indicative of the figure of the AR content is generated, a process to convert the coordinates of each of the points, which are defined by the marker coordinate system, into coordinates in the camera coordinate system, and a process to project each of the points, which are transformed into coordinates in the camera coordinate system, onto the display device plane surface in order to draw each of the points on the display device are performed. Further, the AR content is superimposedly displayed by drawing the image data indicative of the figure of the AR content with the image data acquired from the camera so as to overlap.

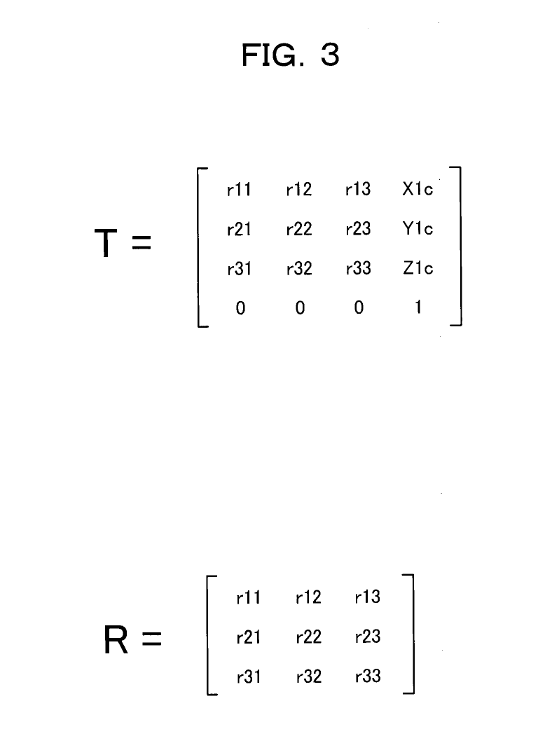

Hereinafter, each of the transformation processes will be described. First, FIG. 3 illustrates a transformation matrix T and a rotation matrix R which convert the marker coordinate system to the camera coordinate system. The transformation matrix T is a determinant for transforming each of the points of the AR content, defined by the marker coordinate system, from the marker coordinate system into the camera coordinate system based on the coordinate values (X1c, Y1c, Z1c) in the camera coordinate system of Om which is the origin of the marker coordinate system and the rotary coordinates G1c (P1c, Q1c, R1c) of the marker coordinate system with regard to the camera coordinate system.

The transformation matrix T is a 4×4 matrix. A column vector (Xc, Yc, Zc, 1) relative to the coordinates Vc corresponding to the camera coordinate system is acquired by multiplying the transformation matrix T by the column vector (Xm, Ym, Zm, 1) relative to the coordinates Vm of the marker coordinate system.

When the partial matrix (rotation matrix R) having first to third rows and first to third columns of the transformation matrix T operates as the coordinates of the marker coordinate system, a rotation operation is performed to combine the direction of the marker coordinate system with the direction of the camera coordinate system. When the partial matrix having first to third rows and a fourth column of the transformation matrix T operates, a translation operation is performed to combine the direction of the marker coordinate system with the position of the camera coordinate system.

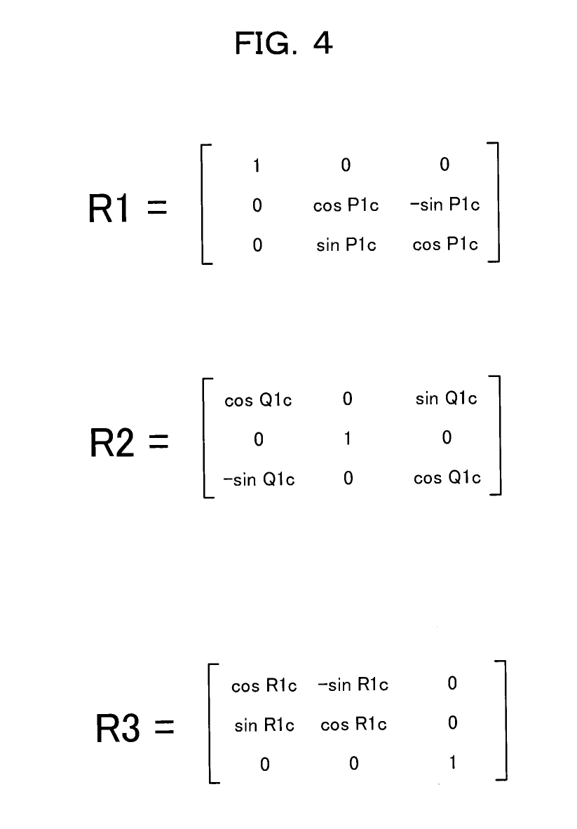

FIG. 4 illustrates rotation matrixes R1, R2, and R3. The rotation matrix R illustrated in FIG. 3 is calculated through the product of the rotation matrixes R1, R2, and R3 (R1·R2·R3). In addition, rotation matrix R1 expresses the rotation of an Xm axis with regard to an Xc axis. The rotation matrix R2 expresses the rotation of a Ym axis with regard to a Yc axis. The rotation matrix R3 expresses the rotation of a Zm axis with regard to a Zc axis.

The rotation matrixes R1, R2, and R3 are generated based on the figure of the marker within an imaged image. That is, the rotary angles P1c, Q1c, and R1c are calculated based on the imaged figure of the marker, which has an already-known form, in the imaged image which is a process target, as described above. Each of the rotation matrixes R1, R2, and R3 is generated based on the calculated rotary angles P1c, Q1c, and R1c.

As described above, a column vector (Xc, Yc, Zc, 1), which includes the point coordinates of the camera coordinate system, is acquired by performing a matrix operation by substituting the point coordinates of the marker coordinate system which is a coordinate transformation target for a column vector (Xm, Ym, Zm, 1). That is, it is possible to transform a point (Xm, Ym, Zm) of the marker coordinate system into a point of the camera coordinate system (Xc, Yc, Zc). The coordinate transformation is called a model view transformation.

For example, when model view transformation is performed on the reference point V2m of the AR content C as illustrated in FIG. 2, a point V2c(X2c, Y2c, Z2c) in the camera coordinate system, which corresponds to the reference point V2m stipulated by the marker coordinate system, is acquired. In the process until now, the position of the AR content with regard to the camera (the positional relationship between the camera and the AR content) is calculated by using the marker.

Subsequently, the coordinates of the camera coordinate system of each of the points of the AR content C are transformed into the coordinates of the screen coordinate system. The screen coordinate system includes two-dimensions (Xs, Ys). Further, when the coordinates of each of the points of the AR content C, which are transformed into the coordinates of the camera coordinate system, are projected on a two-dimensional plane surface (Xs, Ys) which is a virtual screen, the figure of the AR content C which is AR displayed is generated. That is, a part of the screen coordinate system corresponds to the display screen of the display device. Transformation performed on the coordinates of the camera coordinate system into the screen coordinate system is called perspective transformation.

Here, setting is made such that a virtual screen, which is the plane of projection, is parallel to, for example, the Xc-Yc plane surface of the camera coordinate system at a prescribed distance in the Zc direction. At this time, when the origin Oc(0, 0, 0) in the camera coordinate system is set to a certain distance from the focus of the camera in the Zc direction, the origin (0, 0) in the screen coordinate system corresponds to one point on the optical axis of the camera.

The perspective transformation is performed based on, for example, the focal distance f of the camera. The Xs coordinates of the coordinates of the screen coordinate system, which correspond to the coordinates (Xc, Yc, Zc) in the camera coordinate system, are acquired using the following Equation 1. In addition, the Ys coordinates of the coordinates of the screen coordinate system, which correspond to the coordinates (Xc, Yc, Zc) in the camera coordinate system, are acquired using the following Equation 2.

Xs=f·Xc/Zc (Equation 1)

Ys=f·Yc/Zc (Equation 2)

The figure of the AR content C is generated based on the coordinate values of the screen coordinate system, which are acquired through the perspective transformation. The AR content C is generated by mapping a texture, acquired by interpolating a plurality of dots included in the AR content C, on a surface. A template of the original AR content C is defined with dots to be interpolated in order to form a surface and a surface and texture to be mapped.

### First Embodiment

As described above, the coordinates of each of the points which are included in the AR content C are transformed from the marker coordinate system into coordinates in the camera coordinate system and into the screen coordinate system. Thereafter, a drawing process is performed on the display device using the coordinates of each of the points (screen coordinate system) of the AR content C. However, the figure of the AR content C, which exists in a position beyond a range which can be displayed by the display device, is obviously not displayed within the display device.

The inventor notices that there is a case in which the figure of the AR content C, the arrangement of which is determined relative to the marker, is not superimposedly displayed with the synthesized image which is displayed on the display device depending on the positional relationship between the camera and the marker even when the marker is recognized from the image data acquired from the camera.

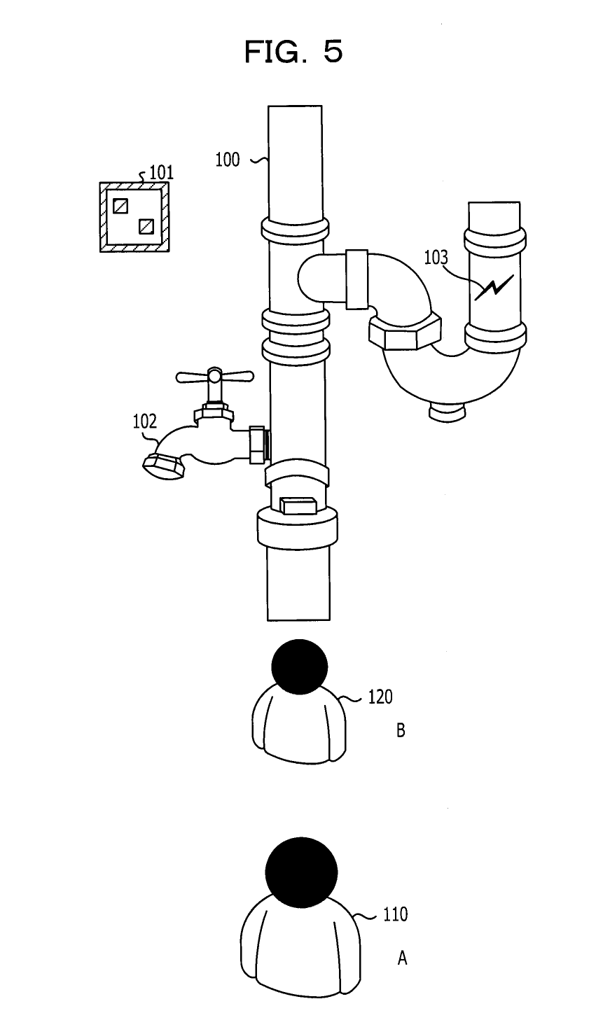

A case, in which the figure of the AR content C is not superimposedly displayed on the image which is displayed on the display device, will be described with reference to FIGS. 5 to 8. FIG. 5 illustrates an image in the real world viewed from a certain point of view. In FIG. 5, a valve 102 is attached to a pipe 100, and a crack 103 exists on the pipe. In addition, a marker 101 is stuck on the back side wall of the pipe. Further, a user 110 photographs the real world from a position A so as to include the marker 101 using a camera. In addition, a user 120 photographs the real world from a position B so as to include the marker 101 using a camera. The position A of the user 110 is a position farther from the marker than the position B of the user 120.

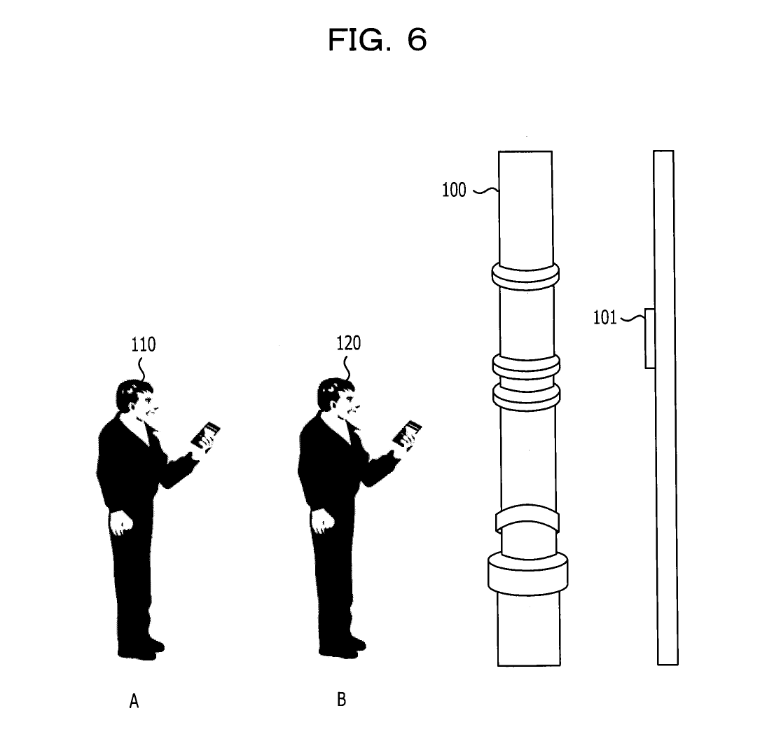

FIG. 6 illustrates an image in the real world viewed from another point of view. A pipe 100 in FIG. 6 is the same object as the pipe 100 in FIG. 5, and a marker 101 is the same object as the marker 101 in FIG. 5. In FIG. 6, the valve 102 and the crack 103 are not illustrated in the drawing. As illustrated in FIG. 6, the user 120 more closely photographs the marker 101 than the user 110.

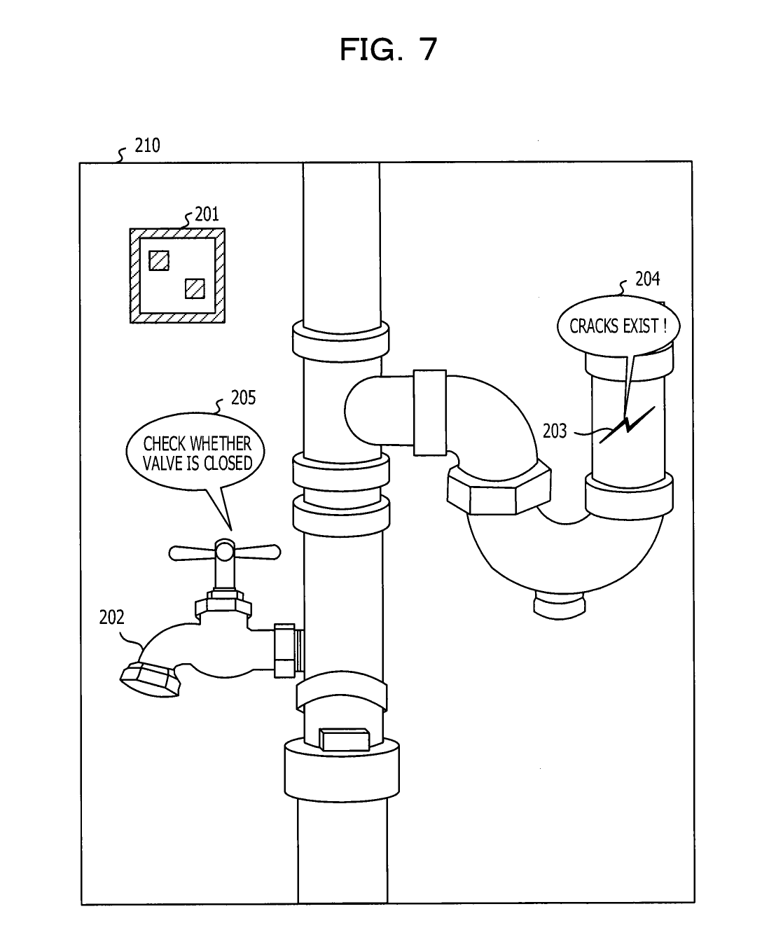

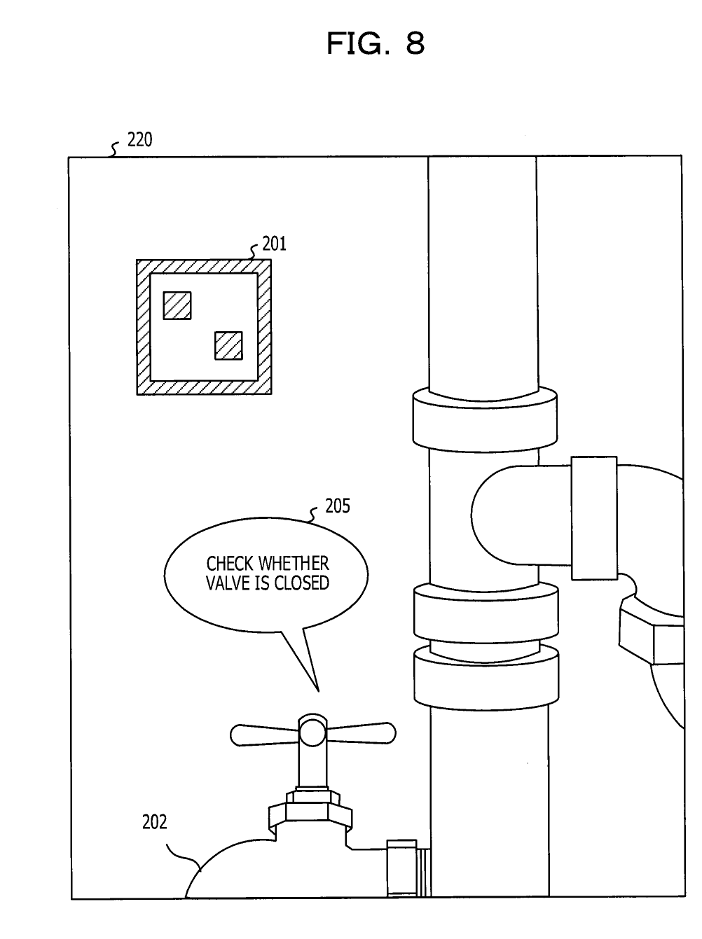

FIG. 7 illustrates an image of AR display based on the image photographed by the user 110. FIG. 8 illustrates an image of AR display based on the image photographed by the user 120. As illustrated in FIG. 7, AR content 204 and AR content 205 are superimposedly displayed on a synthesized image 210 in which AR display is performed on the image photographed from the position A. Therefore, the user 110 is able to perform an operation (crack recognition) instructed by the AR content 204 and an operation instructed by the AR content 205.

In contrast, as illustrated in FIG. 8, the AR content 205 is superimposedly displayed but the AR content 204 is not superimposedly displayed in a synthesized image 220 in which AR display is performed on the image photographed from the position B. Therefore, it is difficult for the user 120 to perform the operation (crack recognition) according to the AR content 204. Although FIG. 8 illustrates a process result (comparative example) according to the related-art technology, display as illustrated in FIG. 8 is temporally performed even in each of the embodiments which will be described below.

Subsequently, further problems will be described. Even when the user is able to find that the AR content 204, which has to be superimposedly displayed, is not superimposedly displayed using some kind of method, the user has to move to a photographing position, where the AR content 204 can be superimposedly displayed, based on the user's judgment after the user finds the existence of the AR content 204 which is difficult to be superimposedly displayed.

Unless a position, in which the AR content (for example, the AR content 204) which is not superimposedly displayed is arranged, is detected in advance, the user moves back or moves in right and left directions based on the user's feeling. Further, the user has to repeatedly move little by little and specify a position in which the AR content 204 is superimposedly displayed. That is, a large amount of load is imposed on the user until the AR content 204 is superimposedly displayed.

Here, when, for example, image data which is being photographed is displayed and it is detected that specific image data is included in the image data, a display apparatus which will be described below is a display apparatus which superimposedly displays another image data on the image data in a state in which the predetermined positional relationship between another image data relative to the specific image data and the specific image data is held, and notifies a photographer of guide information to determine a photographing position or a photographing direction based on at least one of the display position and the size of the specific image data.

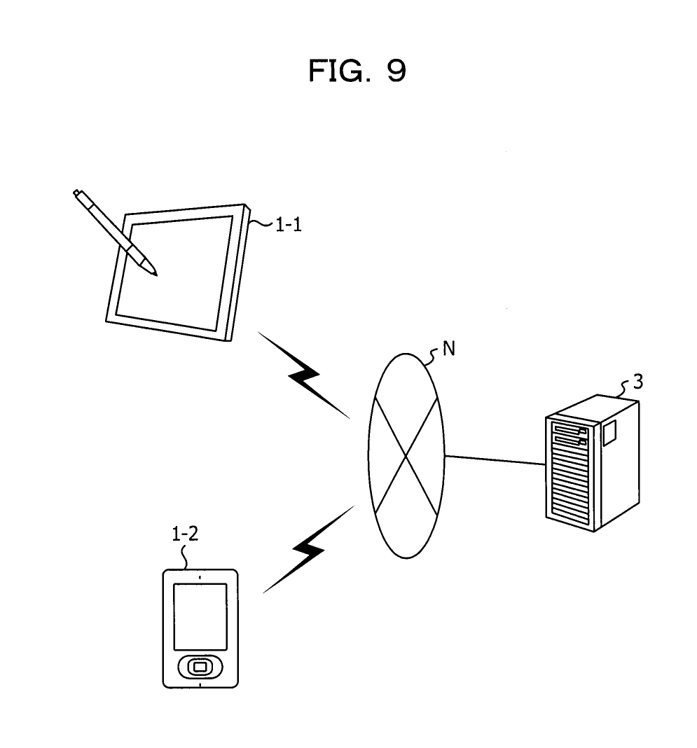

FIG. 9 illustrates the configuration of a system according to a first embodiment. In an example of FIG. 9, a communication terminal 1-1 and a communication terminal 1-2 are illustrated as an example of the display apparatus which performs AR display. Hereinafter, the communication terminal 1-1 and the communication terminal 1-2 are collectively called a display apparatus 1. Further, the display apparatus 1 communicates with a management apparatus 3 through a network N.

The display apparatus 1 is, for example, a computer, such as a tablet PC or a smart phone, which includes an imaging apparatus, such as a camera, and a display device. The management apparatus 3 is, for example, a server computer, and manages the display apparatus 1. The network N is, for example, the Internet. A system according to the embodiment includes the display apparatus 1 and the management apparatus 3.

The display apparatus 1 generates synthesized image data by superimposing another image data (AR content) on image data acquired from a camera. At this time, when the image data acquired from the camera includes specific image data (marker), the display apparatus 1 superimposedly displays another image data (AR content) depending on a position predetermined with regard to the marker. At this time, the display apparatus 1 notifies the photographer of the guide information to determine the photographing position or the photographing direction based on at least one of the display position and the size of the specific image data. For example, the display apparatus 1 outputs a synthesized image which includes the guide information.

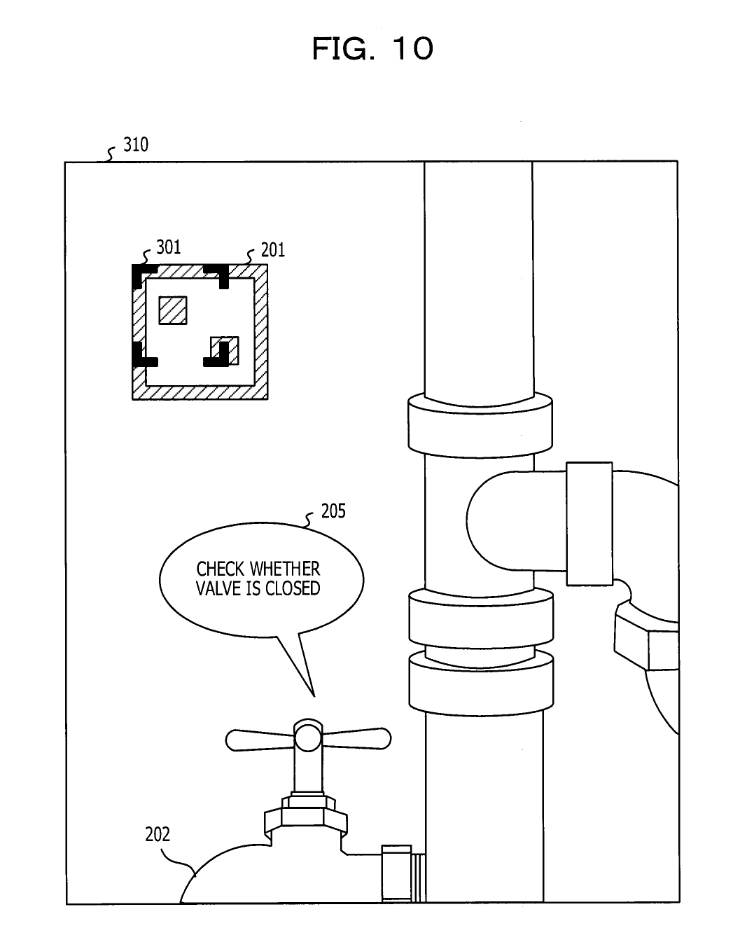

FIG. 10 illustrates an example of the guide information. A synthesized image 310 illustrated in FIG. 10 displays guide information 301. A marker 201, a valve 202, and AR content 205 which are photographed in the synthesized image 310 correspond to the marker 201, the valve 202, and the AR content 205 of the synthesized image 220 illustrated in FIG. 8. That is, when the synthesized image 220 as illustrated in FIG. 8 is generated, the display apparatus 1 generates the synthesized image 310 which includes the synthesized image 220 and the guide information 301, and outputs the synthesized image 310.

Here, the guide information 301 is information for guiding the photographing position or the photographing direction of the user (photographer). In the embodiment, the marker 201 which is currently photographed guides photographing in the photographing position which is applicable to a frame illustrated in the guide information 301. Accordingly, the user reads the synthesized image 310 and photographs after moving backward such that the marker 201 is applicable to the frame illustrated in the guide information 301 in order to superimposedly display the AR content 205. Generation of the guide information will be described in detail in an embodiment below.

Returning to FIG. 9, the management apparatus 3 stores AR content information and template information, and supplies the AR content information and the template information to the display apparatus 1 if occasion calls. The AR content information is information relevant to the AR content of a target to be AR displayed. The template information is information in which the form, the shape, or the like of a template is defined when the AR content is generated using the template. The AR content information and the template information will be described in detail later.

The display apparatus 1 acquires the AR content information and the template information from the management apparatus 3 before AR display is performed. Although the management apparatus 3 stores the AR content information relevant to a plurality pieces of AR content and the template information relevant to a plurality of templates, the management apparatus 3 may provide only the AR content information relevant to a part of the AR content and the template information relevant to a part of templates to the display apparatus 1. For example, the management apparatus 3 provides only the AR content which has a possibility that is able to be provided to the user and the template related to the AR content to the display apparatus 1 according to the attribute of the user who operates the display apparatus 1.

In addition, the display apparatus 1 may transmit the image data of the process target to the management apparatus 3, the synthesized image data according to the AR display may be generated by the management apparatus 3, and the synthesized image data may be transmitted to the display apparatus 1 from the management apparatus 3.

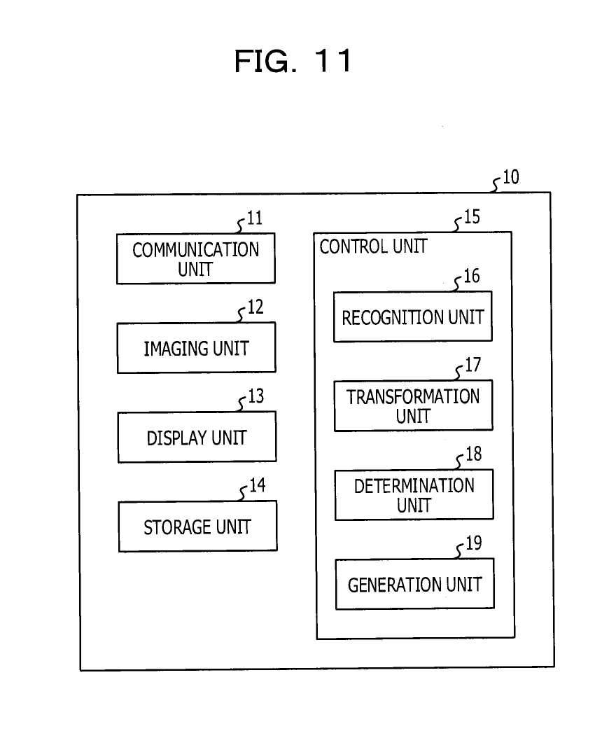

Subsequently, the functional configuration of the display apparatus 10 according to the first embodiment will be described. FIG. 11 is a functional block diagram illustrating the function of the display apparatus 10 according to the first embodiment. The display apparatus 10 includes a communication unit 11, an imaging unit 12, a display unit 13, a storage unit 14, and a control unit 15. An example of the above-described display apparatus 1 is the display apparatus 10 in the first embodiment.

The communication unit 11 communicates with another computer. For example, the communication unit 11 receives the AR content information and the template information from the management apparatus 3 in order to generate the synthesized image data. The imaging unit 12 performs photographing at a certain frame interval, and generates the image data. Further, the imaging unit 12 inputs the image data to the control unit 15.

The display unit 13 displays various image data acquired from the control unit 15 in real time. The various image data includes the image data acquired by the imaging unit 12 and the synthesized image data generated by the control unit 15. The storage unit 14 stores various information under the control of the control unit 15. The storage unit 14 stores the AR content information and the template information. The storage unit 14 may temporarily store the image data acquired from the imaging unit 12.

The control unit 15 controls various processes of the whole display apparatus 10. For example, as will be described later, the control unit 15 performs a real-time process on the image data acquired from the imaging unit 12, and generates the synthesized image data. In addition, the control unit 15 includes a recognition unit 16, a transformation unit 17, a determination unit 18, and a generation unit 19.

The recognition unit 16 performs object recognition for input image data. More specifically, the recognition unit 16 determines whether or not the input image data includes the image data of the marker using an object recognition template in which the form of the marker is defined.

Further, when it is determined that the input image data includes the image data of the marker, the recognition unit 16 generates area information indicative of the area of the marker in the input image data. For example, the area information corresponds to the coordinate values of four vertexes which are included in the marker. The area information is input to a generation unit 19 which will be described later.

In addition, the recognition unit 16 calculates the positional coordinates and the rotary coordinates of the marker based on the area information. The positional coordinates and the rotary coordinates of the marker are values in the camera coordinate system. The recognition unit 16 outputs the calculated positional coordinates and the rotary coordinates to the transformation unit 17. When it is determined that the image data does not include the image data of the marker, the recognition unit 16 outputs the gist of the failure in recognition to the transformation unit 17.

Further, when the recognition unit 16 recognizes that the image data includes the image data of the marker, the recognition unit 16 acquires identification information to identify the marker. For example, a marker ID is acquired. For example, similarly to a two-dimensional bar code, a unique marker ID is acquired from the arrangement of a white part and a black part. Another already-known method may be used as a method of acquiring the marker ID.

The transformation unit 17 generates the synthesized image data in order to perform AR display based on the positional coordinates, the rotary coordinates, the marker ID, the AR content information, and the template information. Here, in order to describe the process performed by the transformation unit 17, the AR content information and the template information will be described. The AR content information and the template information are acquired from the management apparatus 3 and stored in the storage unit 14.

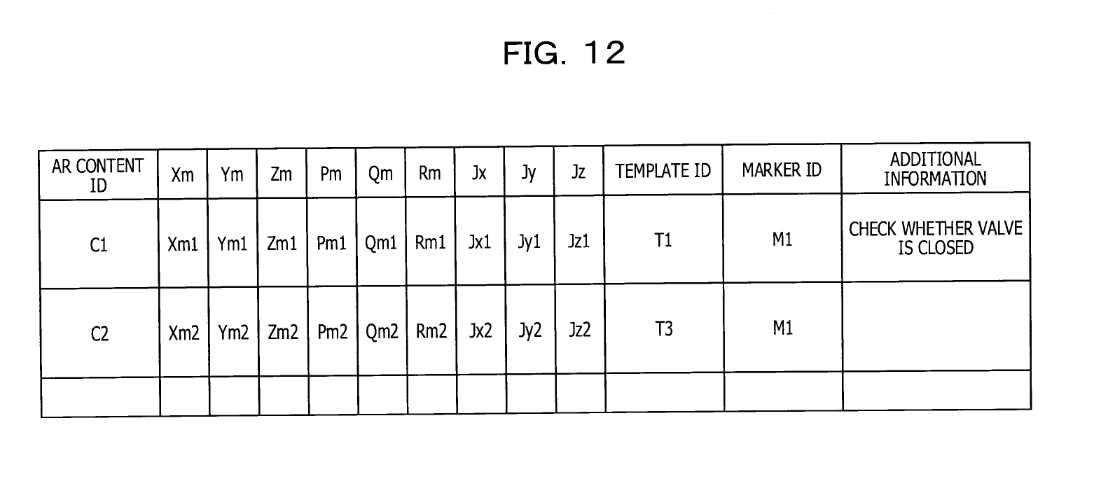

FIG. 12 illustrates an example of the configuration of a data table which stores the AR content information. The AR content information includes at least an AR content ID, the positional information, and the rotary information. Further, the AR content information may include magnification information, a template ID, a marker ID, and additional information.

The AR content ID, the positional information and the rotary information of the AR content in the marker coordinate system are associated with each other and stored in the data table. The AR content ID is identification information to uniquely identify the AR content. The positional information is information to designate the position of the AR content with regard to the marker, and is, for example, the positional coordinates (Xm, Ym, Zm) of the reference point, which forms the AR content, in the marker coordinate system. The rotary information is information to designate the rotation of the AR content with regard to the marker, and is, for example, the rotary coordinates (Pm, Qm, Rm) of the AR content with regard to the marker coordinate system. The positional information and the rotary information is information to determine the arrangement of the AR content.

In addition, when the model form of the AR content is prepared using a template, the template ID and the magnification information are stored in the data table. The template ID is identification information to identify a template which is applied to the AR content. The magnification information is information about the magnification D acquired when the template is applied as the AR content, and is, for example, magnification (Jx, Jy, Jz) to perform enlargement or reduction in each axis direction.

Further, when transformation is performed on the AR content to be AR displayed according to the recognized identification information of the marker, the marker ID of the marker which is associated with each AR content is stored in the data table. Even in the same marker, when transformation is performed on the AR content to be AR displayed according to the attribute information of the user, information which identifies the attribute of the user is further stored with regard to each AR content in association with the marker ID.

The data table may further store the additional information. For example, information of text drawn within the AR content is stored as the additional information. In the example of the AR content ID “C1” of FIG. 12, a text “check whether a valve is closed” is drawn within the AR content.

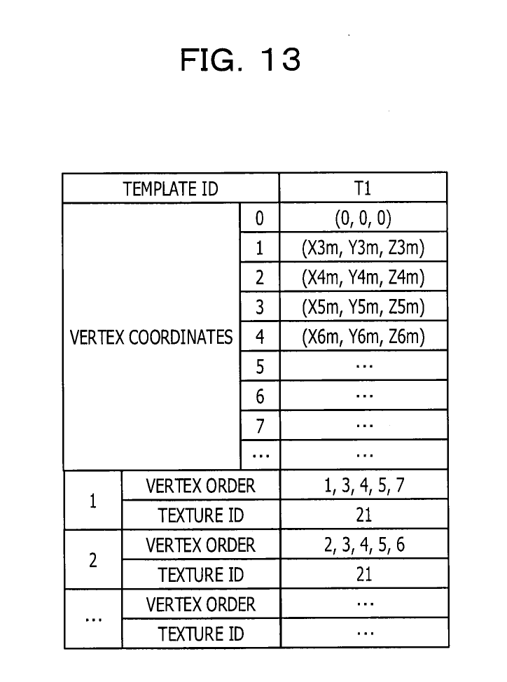

FIG. 13 illustrates an example of the configuration of the data table which stores the template information. The template information includes template identification information (template ID), coordinates information of each vertex which forms the template, and configuration information of each surface which forms the template (designation of vertex order and texture ID).

The vertex order expresses the order of vertexes which form the surface. The texture ID expresses identification information of texture which is mapped to the surface. The reference point of the template is, for example, 0-th vertex. The form and shape of a three-dimensional model are prescribed based on information expressed in a template information table.

When the transformation unit 17 generates the synthesized image data, the AR content ID of the AR content to be AR displayed is specified according to the marker ID acquired from the recognition unit 16. Further, the image data to superimpose the AR content is generated using the corresponding AR content information, the template information, and the positional coordinates and the rotary coordinates calculated by the recognition unit 16. Image data for superimposition is data corresponding to a figure acquired when the AR content is arranged in a position designated in advance with regard to the marker in a virtual space and the AR content is projected onto a virtual screen. Further, the transformation unit 17 generates the synthesized image data by overlapping the image data acquired from the camera with the image data for superimposition.

For example, the AR content in which the AR content ID illustrated in FIG. 12 is “C1” is formed by the respective vertexes which are acquired in such a way that each of the vertex coordinates defined in a template “T1” of FIG. 13 is expanded or reduced in each of the Xm, Ym, and Zm directions, rotated at the rotary coordinates (Pm1, Qm1, Rm1), and translated according to the positional coordinates (Xm1, Ym1, Zm1).

As described above, the transformation unit 17 performs coordinate transformation on the coordinates of each of the points of the AR content from the marker coordinate system to the camera coordinate system using the AR content information, the template information, and the transformation matrix T. Further, the transformation unit 17 transforms the camera coordinate system into the screen coordinate system using the above-described Expression 1 and Expression 2. Further, the transformation unit 17 generates the figure of the AR content (image data) to be superimposedly displayed by mapping the texture defined in the template information with the additional information defined in the AR content information on a surface which forms the AR content.

Returning to FIG. 11, the determination unit 18 determines whether or not it is possible to superimposedly display the AR content on the image data acquired from the camera based on the arrangement (the positional information and the rotary information) which is predetermined with regard to the marker. More specifically, the determination unit 18 compares the image data generated by the transformation unit 17 with the displayable range of the display device. It is assumed that the resolution of the display device is H×L. A resolution H is the number of pixels which are arranged to correspond to the vertical direction of the display device of FIG. 7 or the like, and the vertical direction of the display device corresponds to the Ys direction of the screen coordinate system. In addition, the resolution L is the number of pixels which are arranged to correspond to the horizontal direction of the display device, and the vertical direction of the display device corresponds to the Xs direction of the screen coordinate system.

When the origin of the screen coordinate is set on the optical axis of the camera and the center of the display device is displayed after being arranged to the origin of the screen coordinate system, the determination unit 18 determines whether or not the Xs coordinate values, which are transformed into the screen coordinate system, are in a range from −L/2 to +L/2 and whether or not the Ys coordinate values are in a range from −H/2 to +H/2 with regard to each of the points which form the AR content.

Further, the determination unit 18 determines whether or not the Zc coordinate values of the AR content, which are transformed into coordinates in the camera coordinate system, exist behind a virtual screen setting position with regard to each of the points which form the AR content based on the virtual screen setting position (position in the Zc direction). The reason for this is that, in a case of the positional relationship in which the AR content is in front of the virtual screen, the AR content is not projected onto the virtual screen. For example, when the virtual screen setting position is a position corresponding to N markers on the Zc axis, it is determined whether or not the Zc coordinate value is greater than N. A unit coordinate in the camera coordinate system corresponds to a single marker 1.

When all the determination results of each of the Xs coordinate value, the Ys coordinate value, and the Zc coordinate value are negative, a determination target point is displayed on the display device when the synthesized image data is displayed on the display device. That is, it is determined that the points which form the AR content are superimposedly displayable. When it is determined that all the points which form the AR content are displayable on the display device, the whole AR content is displayed on the display device.

When it is determined that only some points of the AR content are displayable on the display device, that is, when determination results with regard to some points are positive and determination results with regard to other points are negative, some of the AR content are displayed on the display device but remaining parts are not displayed.

Further, when it is determined that all the points are not displayable on the display device, that is, when determination results with regard to all the points are negative, the AR content is not displayed on the display device. In the embodiment, although the determination unit 18 determines that the AR content is superimposedly displayable based on the determination results of all the points being positive, the determination unit 18 may determine that the AR content is superimposedly displayable if the determination results of some points are positive and the determination results of the other points are negative.

The generation unit 19 generates the guide information based on at least one of the display position and the size of the image data of the marker. In the embodiment, the guide information is generated based on the area information, which is input from the recognition unit 16, and the coordinate values of each piece of AR content in the screen coordinate system, which is acquired through transformation performed by the transformation unit 17.

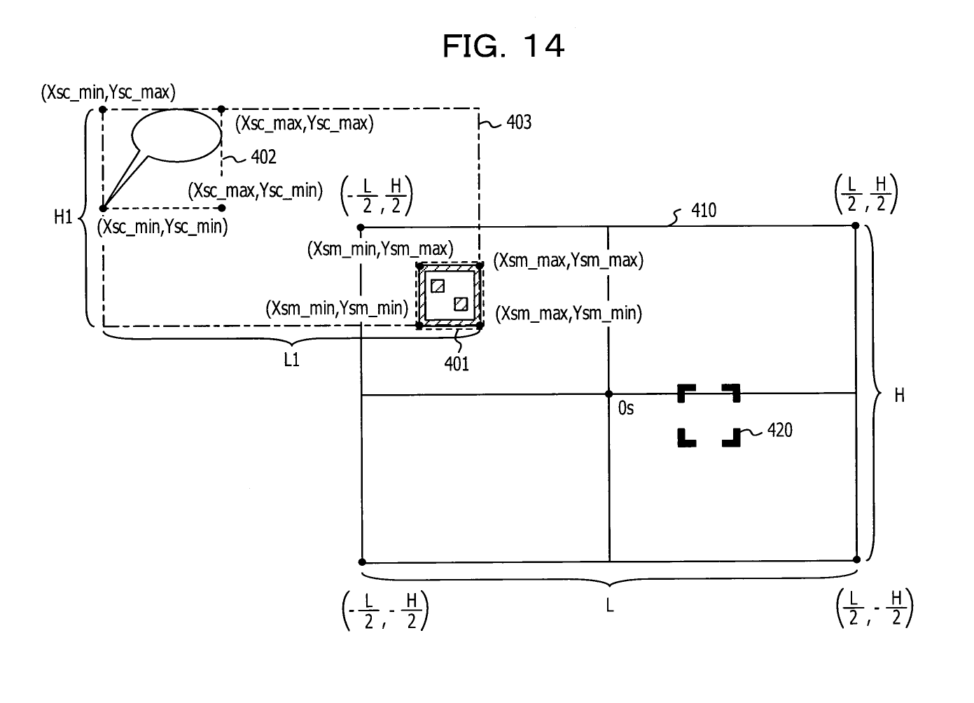

FIG. 14 is a graph illustrating a guide information generation process. For example, the generation unit 19 sets up a first rectangular area which has vertexes (Xsm_max, Ysm_max), (Xsm_max, Ysm_min), (Xsm_min, Ysm_max), and (Xsm_min, Ysm_min) based on the coordinate values of a plurality of points which form the area of the marker. Xsm_max is the maximum value of the Xs coordinate values of the plurality of points which form the area of the marker, and Xsm_min is the minimum value. In addition, Ysm_max is the maximum value of the Ys coordinate values of the plurality of points which form the area of the marker, and Ysm_min is the minimum value.

Subsequently, the generation unit 19 sets up a second rectangular area which has vertexes (Xsc_max, Ysc_max), (Xsc_max, Ysc_min), (Xsc_min, Ysc_max), and (Xsc_min, Ysc_min) based on the coordinate values of a plurality of points which form the AR content. Xsc_max is the maximum value of the Xs coordinate values of the plurality of points which form the area of the AR content, and Xsc_min is the minimum value. In addition, Ysc_max is the maximum value of the Ys coordinate values of the plurality of points which form the area of the AR content, and Ysc_min is the minimum value. In addition, when there is a plurality pieces of AR content, the second rectangular area is set up for each of the pieces of AR content regardless of the AR content being superimposedly displayable on the display device.

Further, the generation unit 19 sets up a third rectangular area which includes the first rectangular area and the second rectangular area. The third rectangular area is a square-shaped area formed by sides which are parallel to the Xs direction and the Ys direction. Further, the length of the Xs direction of the third rectangular area is set to L1 and the length of the Ys direction is set to H1.

First, the generation unit 19 determines whether or not it is possible to superimposedly display the AR content, which is not superimposedly displayable, by only changing the photographing direction. That is, it is determined whether L1 is less than the displayable range L of the display device and whether H1 is less than the displayable range H.

Subsequently, when L1 is less than L and H1 is less than H, the generation unit 19 generates the guide information indicative of a degree of change in the photographing direction. Here, the generation unit 19 calculates the amount of movement in order to cause the third rectangular area to be included within the displayable range of the display device.

For example, the generation unit 19 specifies a point (Xs′, Ys′), which is out of a displayable range and which is the farthest from the displayable range, from among points which form the third rectangular area. Further, the generation unit 19 acquires the differences between the vertex (Xs″, Ys″), which is the closest to the point (Xs′, Ys′), and the point (Xs′, Ys′) from among the four vertexes, which form the displayable range, with regard to the respective Xs and Ys directions. The respective differences in the Xs and Ys directions are the amount of movement to cause the third rectangular area to be included in the displayable range. In the example of FIG. 14, the point (Xs′, Ys′) is a point (Xsc_min, Ysc_max), and the point (Xs″, Ys″) is a point (−L/2, H/2). Further, the amount of movement such that the point (Xsc_min, Ysc_max) coincides with the point (−L/2, H/2) is “−L/2-Xsc_min” in the Xs direction and “H/2-Ysc_max” in the Ys direction.

Subsequently, the generation unit 19 generates the guide information 420 by applying the amount of movement to the first rectangular area 401 corresponding to the marker area. That is, in the example of FIG. 14, the guide information 420 indicative of the area including the four vertexes is generated by moving each of the vertexes which form the first rectangular area 401 by “−L/2-Xsc_min” in the Xs direction and “H/2-Ysc_max” in the Ys direction.

In contrast, when L1 is equal to or greater than L or H1 is equal to or greater than H, it is desired that the photographer performs photographing after moving backward. Accordingly, the generation unit 19 generates the guide information indicative of a degree of the backward movement. More specifically, the generation unit 19 reduces the third rectangular area by a prescribed magnification α (α<1). Further, the generation unit 19 determines whether or not the length L2 of the rectangular, acquired after the reduction is performed, in the Xs direction is less than L and whether the length H2 in the Ys direction is less than H. The generation unit 19 reduces the third rectangular area by the prescribed magnification α until L2 is less than L and H2 is less than H. For example, the prescribed magnification α is 0.8.

Further, the generation unit 19 generates the guide information by multiplying a ratio of L2 to L1, that is, L2/L1 (or H2/H1) by the first rectangular area at a time point in which it is determined that L2 is less than L and H2 is less than H. For example, in the example illustrated in FIG. 10, the guide information 301 guides the photographer to move backward to a degree in which the marker is received in the rectangle of the guide information 301 in order to superimposedly display the AR content 204.

In addition to the above-described method, the generation unit 19 may acquire β which satisfies L1×β<L, and H1×β<H when, for example, L1 is equal to or greater than L or H1 is equal to or greater than H. In this case, guide information, which expresses an area acquired by multiplying the first rectangular area by β, is generated.

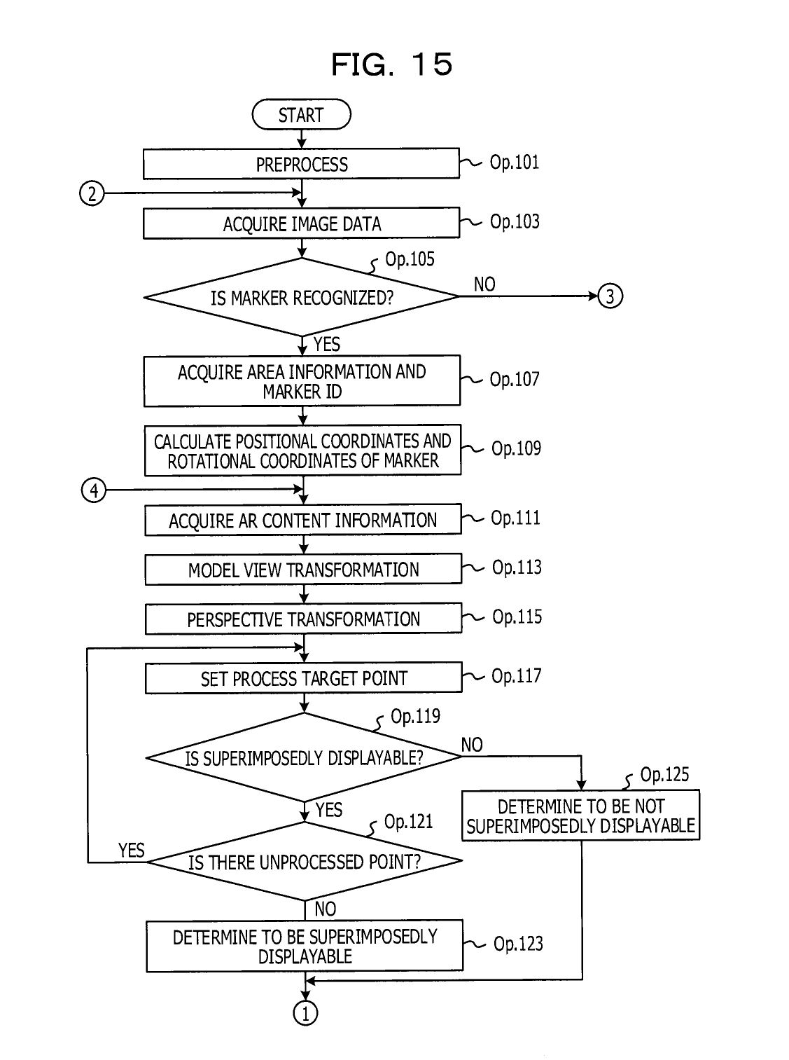

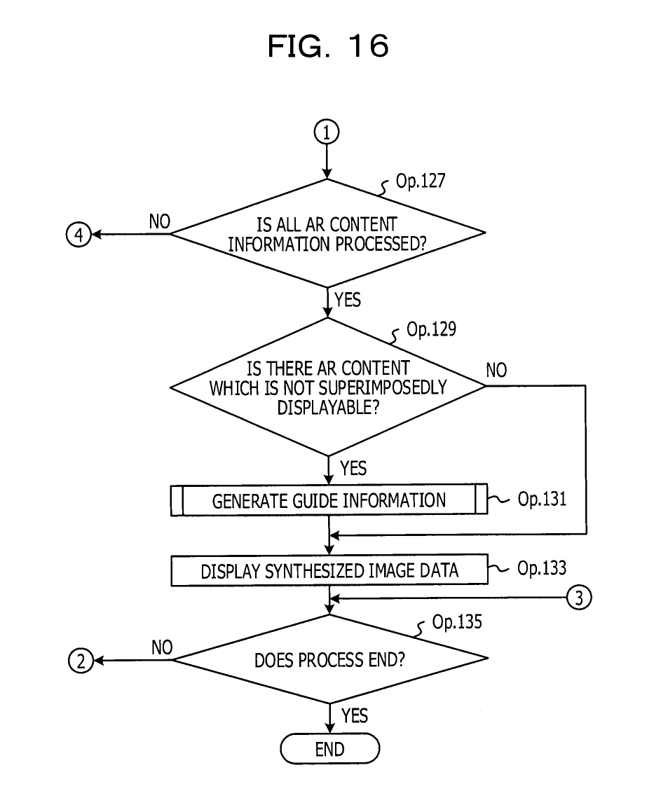

Subsequently, the flow of a process performed by the display apparatus 10 will be described. FIGS. 15 and 16 are flows of the process of the display control method according to the first embodiment. The display control method is performed in such a way that a computer which functions as the display apparatus 10 executes a display control program.

When the display control program is driven, the control unit 15 performs a pre-process (Op. 101). In the process in Op. 101, the template information and the AR content information are acquired from the management apparatus 3. Further, the control unit 15 causes the imaging unit 12 to start to perform imaging at intervals in which the start of an AR display mode is not instructed, for example, at predetermined time intervals. In addition, the control unit 15 causes the recognition unit 16 to start the marker recognition process. When imaging is instructed from the control unit 15, the imaging unit 12 acquires the image data generated by the imaging element at prescribed time intervals, and stores the image data in the storage unit 14.

The storage unit 14 is provided with a buffer which stores a plurality of image data, and the image data is stored in the buffer. For example, the buffer which is provided in the storage unit 14 is a display buffer which stores the image data to be displayed on the display unit 13. The image data to be stored in the display buffer is sequentially transmitted to the display unit 13 and then displayed. In addition, the control unit 15 causes the display unit 13 to start the display of the image data. Here, when the marker is recognized in real time as will be described later, the display unit 13 displays synthesized image data. When the marker is not recognized, the display unit 13 displays an image which is imaged by the imaging unit 12.

The recognition unit 16 acquires the image data which is stored in the buffer provided in the storage unit 14 (Op. 103). Further, the recognition unit 16 performs marker recognition on the acquired image data (Op. 105). When the marker is not recognized (No in Op. 105), the control unit 15 determines whether or not to end the display control process (Op. 135). When it is determined to end the display control process (Yes in Op. 135), the control unit 15 ends a series of display control processes. For example, when a user inputs a gist to end the display control process relevant to the AR display, the control unit 15 ends the display control process. In contrast, when it is determined not to end the display control process (No in Op. 135), the control unit 15 repeatedly performs the processes after Op. 103 on new image data.

In contrast, when the marker is recognized (Yes in Op. 105), the recognition unit 16 acquires the area information and reads the marker ID of the marker (Op. 107). The recognition unit 16 extracts feature points corresponding to the corners of the marker, and generates the coordinate values of the feature points as the area information.

In addition, the marker ID is read based on, for example, information of brightness within the image area corresponding to the marker. For example, when the marker has a square form, the recognition unit 16 sets an area, in which the brightness is equal to or greater than a predetermined value, to “1” and an area, in which the brightness is less than the predetermined value, to “0”, with regard to each of the areas acquired by dividing a square-shaped image area which is recognized as the marker, and determines whether each of the areas is “1” or “0” in prescribed order, and sets the column of information acquired through the determination as the marker ID.

When the marker ID is read, for example, the arrangement of the area, in which the brightness is equal to or greater than the predetermined value, and the area, in which the brightness is less than the predetermined value, within the square-shaped frame may be patterned, and the marker ID corresponding to the pattern may be used. Further, when a numerical value range used as the marker ID is prescribed in advance and the read marker ID is not included in the numerical range, the recognition unit 16 may determine that the marker ID is not read.

Subsequently, the recognition unit 16 calculates the positional coordinates and the rotary coordinates of the marker in the camera coordinate system based on the form and the size of the figure of the marker in the image data (Op. 109). For example, the recognition unit 16 calculates the positional coordinates and the rotary coordinates based on the positions of the four feature points in the area information. The recognition unit 16 outputs the calculated positional coordinates and the rotary coordinates, and the marker ID to the transformation unit 17.

The transformation unit 17 searches a data table, which stores the AR content information, based on the marker ID acquired from the recognition unit 16. Further, the AR content information, which includes the marker ID acquired from the recognition unit 16, is acquired (Op. 111). Further, the corresponding template information is also acquired from the data table, which stores the template information, based on the template ID included in the AR content information.

The transformation unit 17 generates the transformation matrix T using the positional coordinates and the rotary coordinates, which are acquired from the recognition unit 16, and performs the model view transformation on the respective points, which are defined as the AR content information and the template information, using the transformation matrix T (Op. 113). That is, the transformation unit 17 transforms the coordinates of each of the points, which are defined in the marker coordinate system, into coordinates in the camera coordinate system. Further, the transformation unit 17 transforms the coordinates of each of the points, which are displayed in the camera coordinate system, into the coordinates in the screen coordinate system (Op. 115). That is, the perspective transformation is performed.

Subsequently, the determination unit 18 sets a process target point from among the plurality of points (screen coordinate system) which form the figure of the AR content (Op. 117). Further, the determination unit 18 determines whether or not the process target point is included in the displayable range of the display unit 13 (display device) (Op. 119). That is, the determination unit 18 determines whether or not a part corresponding to the process target point of the AR content is superimposedly displayable. When determination is performed, Zc of the camera coordinate system, which is calculated before the perspective transformation is performed, is also used in addition to Xs and Ys of the screen coordinate system, as described above.

When the part corresponding to the process target point of the AR content is superimposedly displayable (Yes in Op. 119), the determination unit 18 determines whether or not there is an unprocessed point (Op. 121). When there is an unprocessed point (Yes in Op. 121), the determination unit 18 newly sets up a process target point (Op. 117). In contrast, when the part corresponding to the process target point of the AR content is not superimposedly displayable (No in Op. 119), the determination unit 18 determines that the AR content, which includes the process target point, is not superimposedly displayable (Op. 125).

In contrast, when there is no unprocessed point (No in Op. 121), that is, when it is determined that all of the points are superimposedly displayable, the determination unit 18 determines that the AR content is superimposedly displayable (Op. 123). In the embodiment, when it is determined that at least one point is not superimposedly displayable, it is determined that the AR content is not superimposedly displayable. However, if the process in Op. 119 is performed on all of the points and more than half of the points are not superimposedly displayable, the determination unit 18 may determine that the AR content is not superimposedly displayable. In addition, the AR content in which all of the points are superimposedly displayable, the AR content in which some points are superimposedly displayable, and the AR content in which all of the points are not superimposedly displayable may be identified as three kinds.

Subsequently, the determination unit 18 determines whether or not all pieces of AR content information related to the marker ID information are determined whether or not to be superimposedly displayable (Op. 127). When there is unprocessed AR content information corresponding to the marker ID (No in Op. 127), various processing units within the control unit 15 receive the output of the determination results acquired by the determination unit 18, and perform processes after Op. 111. For example, when a plurality of pieces of AR content is set for a single marker, the processes after Op. 111 are repeated using the AR content information corresponding to each piece of AR content.

When a plurality of marker IDs are acquired in Op. 107, the recognition unit 16 calculates the positional coordinates and the rotary coordinates of each of the markers in Op. 109. Even in this case, the processes after Op. 111 are repeatedly performed on each of the pieces of AR content information, acquired based on each of the marker IDs, based on each of the positional coordinates and the rotary coordinates of each of the markers.

In contrast, when all the pieces of AR content information is processed (Yes in Op. 127), the determination unit 18 determines whether or not there is the AR content which is not superimposedly displayable (Op. 129). When there is the AR content which is not superimposedly displayable (Yes in Op. 129), the generation unit 19 performs the guide information generation process (Op. 131). The process will be described in detail later.

Further, the generation unit 19 may collectively generate reference information together with the guide information. For example, the reference information is a message or audio which informs that there is content which is difficult to be superimposed. Further, when the camera (imaging unit 12) includes a zoom lens, the control unit 15 controls the zoom lens of the camera after receiving the determination results acquired by the determination unit 18. Further, the camera may photograph an image having further wide angles.

After the guide information generation process is performed or when there is not the AR content which is not superimposedly displayable (No in Op. 129), the display unit 13 displays the synthesized image data (Op. 133). At this time, the display unit 13 displays the synthesized image data under the control of the generation unit 19. The generation unit 19 outputs the image data of the figure of the AR content generated by the transformation unit 17, the image data acquired from the imaging unit 12, and the synthesized image data, which includes the guide information when the guide information is generated, to the display unit 13.

For example, the synthesized image data, acquired when the guide information generation process is performed, includes at least the image data imaged by the imaging unit 12, the guide information, and the AR content acquired when there is the AR content which is superimposedly displayable. In contrast, when there is not the AR content which is not superimposedly displayable, the synthesized image data includes at least the image data imaged by the imaging unit 12, and the image data of the figure of the AR content.

Further, after the display unit 13 displays the synthesized image data, the control unit 15 determines whether or not to end the process (Op. 135). When there is an input of a gist to end the process (Yes in Op. 135), a series of display control processes are ended.

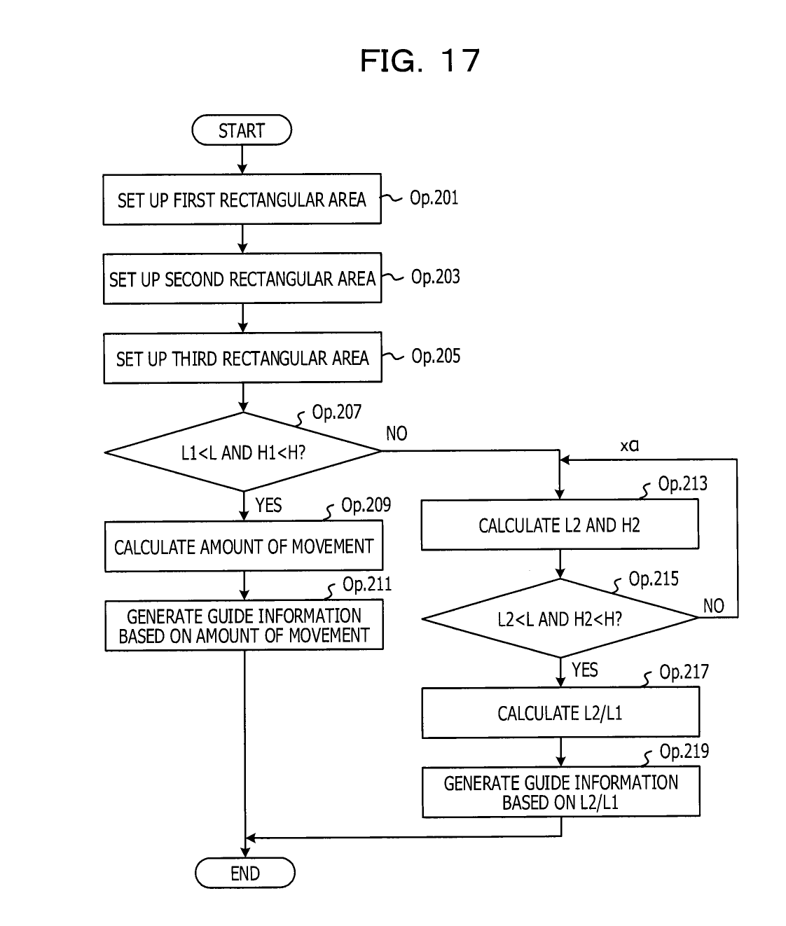

Subsequently, the guide information generation process will be described. FIG. 17 is a flowchart illustrating the guide information generation process. When it is determined that there is the AR content which is not superimposedly displayable (Yes in Op. 129 of FIG. 16), the determination unit 18 inputs the result of determination to the generation unit 19. At this time, the area information and the image data of the figure of the AR content are collectively input. The arrangement position of the image data of the figure of the AR content is defined using the coordinate values of the screen coordinate system through the perspective transformation.

The generation unit 19 first sets up the first rectangular area (Op. 201). For example, the generation unit 19 sets up the first rectangular area which includes vertexes (Xsm_max, Ysm_max), (Xsm_max, Ysm_min), (Xsm_min, Ysm_max), and (Xsm_min, Ysm_min) based on the coordinate values of the plurality of points which form the marker, as illustrated in FIG. 14.

Subsequently, the generation unit 19 sets up the second rectangular area (Op. 203). For example, the generation unit 19 sets up the second rectangular area which includes vertexes (Xsc_max, Ysc_max), (Xsc_max, Ysc_min), (Xsc_min, Ysc_max), and (Xsc_min, Ysc_min) based on the coordinate values of the plurality of points which form the AR content, as illustrated in FIG. 14. When there are a plurality of pieces of AR content, the second rectangular area is set up for each of the pieces of AR content.

Further, the generation unit 19 sets up the third rectangular area (Op. 205). The generation unit 19 sets up the third rectangular area which includes the first rectangular area and the second rectangular area. Subsequently, the generation unit 19 acquires the lengths L1 and H1 of the respective sides of the third rectangular area, and determines whether or not L1 is less than the displayable range L in the Xs direction and H1 is less than the displayable range H in the Ys direction (Op. 207).

When L1 is less than L and H1 is less than H (Yes in Op. 207), the generation unit 19 calculates the amount of movement to cause the third rectangular area to be included within the displayable range (Op. 209). For example, the generation unit 19 specifies a point (Xs′, Ys′) which is the farthest from the displayable range from among the points which form the third rectangular area. Further, the generation unit 19 calculates the amount of movement by acquiring the differences between the vertex (Xs″, Ys″), which is the closest to the point (Xs′, Ys′), and the point (Xs′, Ys′) from among the four vertexes, which form the displayable range, with regard to the respective Xs and Ys directions.

The generation unit 19 generates the guide information based on the amount of movement (Op. 211). For example, the generation unit 19 generates the guide information indicative of an area acquired by shifting the first rectangular area in parallel in the Xs and Ys directions based on the amount of movement.

In contrast, when L1 is equal to or greater than L or H1 is equal to or greater than H (No in Op. 207), the generation unit 19 calculates L2 and H2 by multiplying the lengths L1 and H1 of the respective sides of the third rectangular area by the prescribed magnification α (Op. 213). Further, the generation unit 19 determines whether or not L2 is less than L and H2 is less than H (Op. 215).

When L2 is less than L and H2 is less than H (Yes in Op. 215), the generation unit 19 calculates a ratio of L2 to L1, that is, L2/L1 (Op. 217). Further, the generation unit 19 generates the guide information based on the ratio L2/L1 (Op. 219). For example, the generation unit 19 generates the guide information indicative of an area acquired by reducing the first rectangular area at the ratio L2/L1 by multiplying the first rectangular area by the ratio L2/L1.

In addition, when L2 is equal to or greater than L or H2 is equal to or greater than H (No in Op. 215), the generation unit 19 updates the values of L2 and H2 by multiplying L2 and H2 by the magnification α (Op. 213), and repeats the process until L2 is less than L and H2 is less than H (Yes in Op. 215).

The guide information is generated by performing the above-described process. When the synthesized image data, which includes the generated guide information, is displayed (Op. 133 of FIG. 16), the user is able to determine the photographing position or the photographing direction to superimposedly display the AR content, which is not superimposedly displayed, while referring to the display based on the guide information.

For example, as illustrated in FIG. 10, the user is able to understand a desired distance to be separated from the marker in order to perform photographing until the marker is photographed with a specific size. In addition, as illustrated in FIG. 14, the user is able to understand the desired amount of change in the photographing direction until the marker is photographed at a specific position. As illustrated in FIGS. 10 and 14, when the guide information is displayed, a guide message “Adjust the photographing position and the photographing direction such that the marker is included in the guide frame” or the like may be collectively displayed.

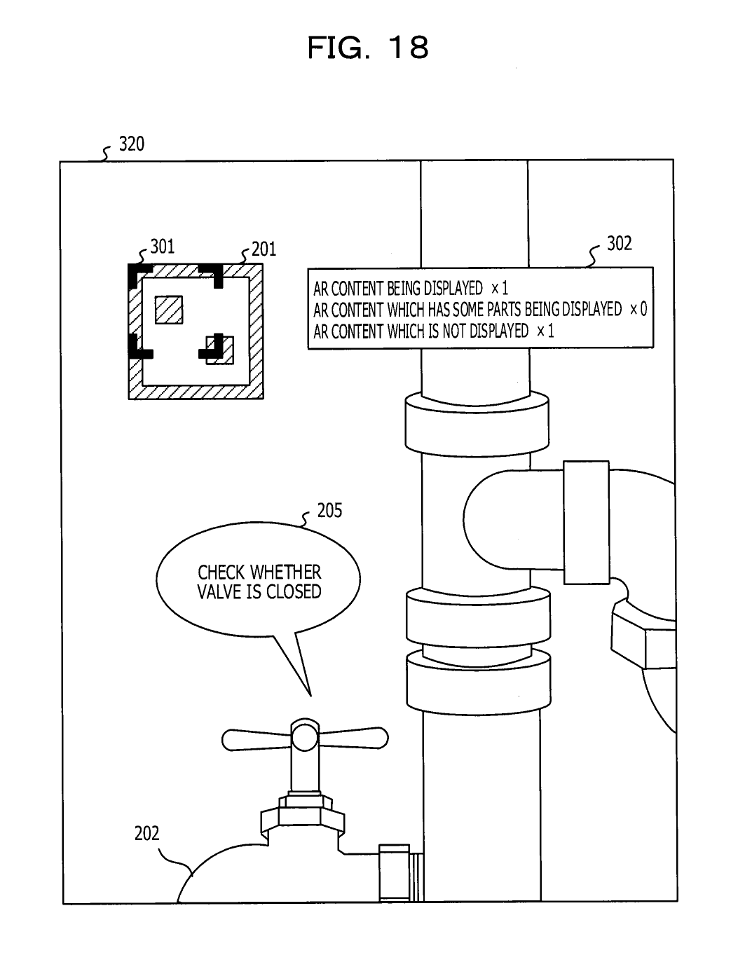

FIG. 18 illustrates the display image of the synthesized image data collectively displaying the guide information and the reference information. Similarly to the synthesized image data 310 illustrated in FIG. 10, the AR content 205 and the guide information 301 are superimposedly displayed on the image, in which the marker 201 and the valve 202 are photographed, in the synthesized image data 320. Further, in the synthesized image data 320, the reference information 302 is also displayed. For example, the reference information is information indicative of AR content which is currently displayed, AR content which has some parts being displayed and the number of pieces of AR content which is not displayed. The user is able to understand the existence of the AR content which is not currently displayed and is able to understand the number of pieces of AR content which is not displayed based on the reference information.

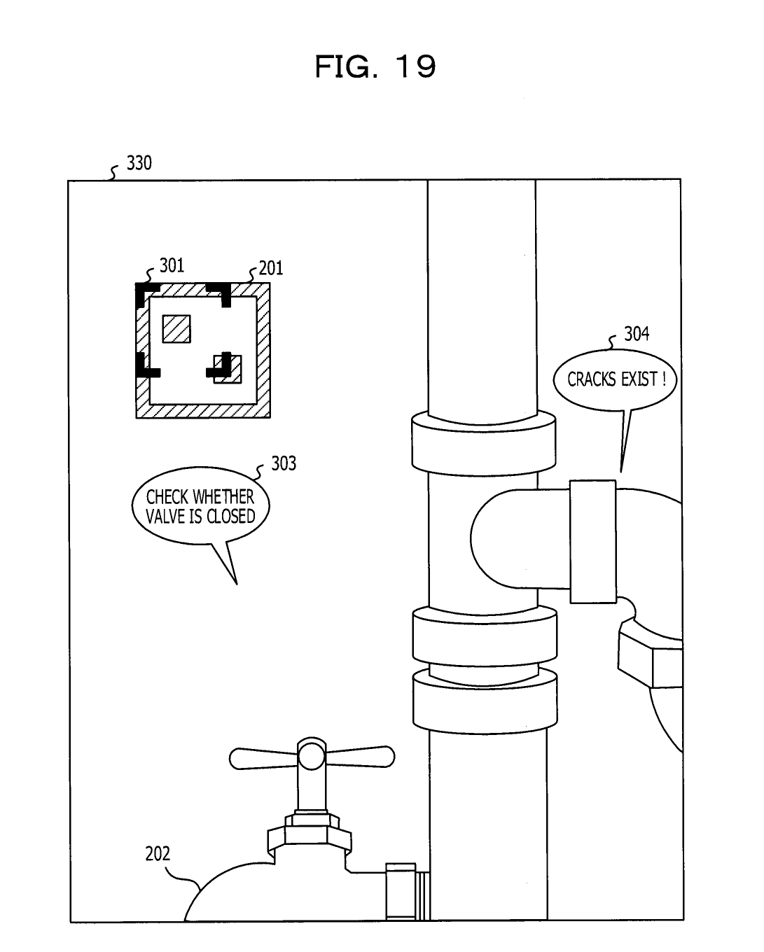

FIG. 19 illustrates the image of another synthesized image data collectively displaying the guide information and the reference information. Similarly to the synthesized image data 310 illustrated in FIG. 10, guide information 301 is superimposedly displayed on the image, in which the marker 201 and the valve 202 are photographed, in the synthesized image data 330. In addition, although the AR content 205 is not displayed in the embodiment, the AR content 205 may be displayed. Further, the synthesized image data 330 is displayed with the reference information 303 and the reference information 304.

The reference information 303 and the reference information 304 are display images of the pieces of AR content which are superimposedly displayed when photographing is performed such that the marker is included in a guide frame indicated by the guide information 301. That is, the recognition unit 16 virtually recognizes an area corresponding to the guide information as the marker, and calculates the positional coordinates and the rotary coordinates of the marker (similar to Op. 109). Further, similarly to Op. 113 and Op. 115, the transformation unit 17 generates the image data of the AR content, acquired when a marker corresponding to the guide information is virtually photographed, by performing a model view transformation process and projection process of the AR content. Further, the transformation unit 17 outputs the image data of the AR content to the display unit 13 as the reference information.

For example, the user who reads the synthesized image data of FIG. 19 is able to acquire the guide information in order to change the photographing position and the photographing direction, and is able to recognize the AR content, which is superimposedly displayed after the change is performed, in advance.

As described above, according to the embodiment, the display apparatus 1 is able to provide the guide information to the photographer in order to determine at least one of the photographing position and the photographing direction such that the AR content which is not superimposedly displayable is superimposedly displayed. When it is determined whether or not the AR content is superimposedly displayable, a method disclosed in Japanese Laid-open Patent Publication No. 2014-010426 may be used.

### Second Embodiment

A second embodiment is used when the user readjusts the arrangement position of the AR content. Although the arrangement of the AR content is determined such that the AR content is displayed for each relevant specific object (a valve or a pipe), the AR content is not directly associated with a specific object in the marker-type vision-based AR. As described above, since the positional information or the rotary information in the marker coordinate system is set as the AR content information, the arrangement of the AR content is determined based on only the marker.

However, in a real space, when a fact that the marker has a prescribed positional relationship with the specific object is used, the AR content indirectly corresponds to a specific object through the marker, and thus it is possible to display the AR content for each specific object.

Here, if the position of the marker (paper on which the marker is printed) is changed, the positional relationship between the marker and the specific object is changed. In contrast, the AR content is arranged according to preset positional information and rotary information. In this case, the AR content, which is arranged using the positional information and the rotary information in the marker coordinate system, is arranged at a position which does not correspond to the specific object. Accordingly, when the position of the marker is changed, the arrangement of the AR content has to be readjusted. The embodiment may be used when, for example, the arrangement of the AR content is readjusted.

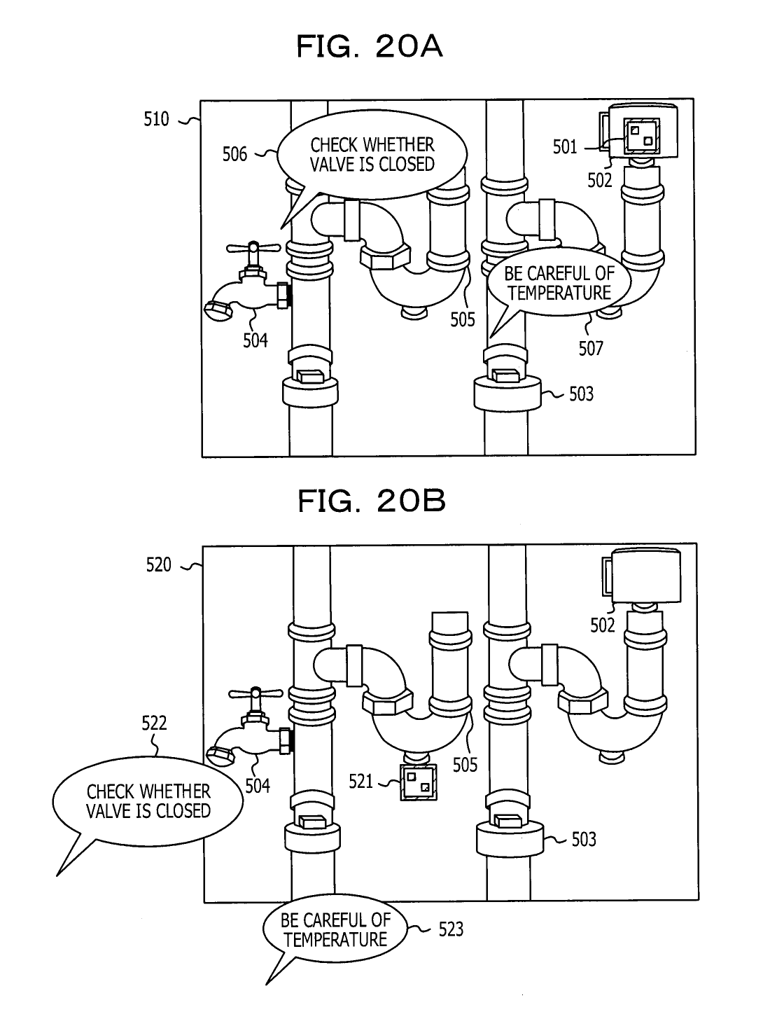

FIGS. 20A and 20B are views illustrating the display state of AR content acquired when the position on which the marker is stuck is changed. FIG. 20A illustrates synthesized image data 510 in which AR content 506 and AR content 507 are superimposedly displayed on image data which is photographed in a first time point.

As illustrated in FIG. 20A, at the first time point, the marker 501 is stuck on the tank 502. Further, the AR content 506 and the AR content 507 are arranged at a prescribed position based on the marker 501. As a result, the AR content 506 is displayed in the vicinity of a valve 504 which has a first positional relationship with the marker 501, and the AR content 507 is displayed in the vicinity of a pipe 503 which has a second positional relationship with the marker 501. The valve 504 is connected to the pipe 505.

Subsequently, FIG. 20B illustrates synthesized image data 520 in which AR content 522 and AR content 523 are superimposedly displayed on image data which is photographed in a second time point. In addition, FIG. 20B illustrates the position on which the marker 521 is stuck in the second time point, and the AR content 522 and the AR content 523 which are arranged according to the marker 521. The shape expressed by marker 521 is the same as that of the marker 501, and the same ID is read.

In FIG. 20B, only a part of the AR content 522 and the AR content 523 is displayed on the display device. However, for convenience of explanation, parts which are out of a displayable range are illustrated in FIG. 20B. In addition, the same reference numeral is attached to an object in FIG. 20B which is the same as the object in FIG. 20A.

As illustrated in FIG. 20B, in the second time point, the marker 521 is hung on the pipe 505 instead of the tank 502. Therefore, the AR content 522 and the AR content 523 are arranged based on the positional information and the rotary information which are associated with the marker ID indicated by the marker 521. That is, like the AR content 522 and the AR content 523, the AR content 506 and the AR content 507 in FIG. 20A are arranged in prescribed positions with regard to the marker 521 while respectively maintaining the positional relationship with the marker 501. When the position on which the marker 521 is stuck is changed, the pieces of AR content 522 and 523 are not arranged in the vicinity of the valve 504 and the pipe 503.

Here, when the position on which the marker 501 is stuck is changed, the user has to set again the positional information and the rotary information of the AR content 506 (522) and the AR content 507 (523) such that the AR content 522 and the AR content 523 are arranged at appropriate positions. The technology disclosed in the embodiment provides an interface to the user in order to virtually receive the change in the arrangement position or the size of the marker.

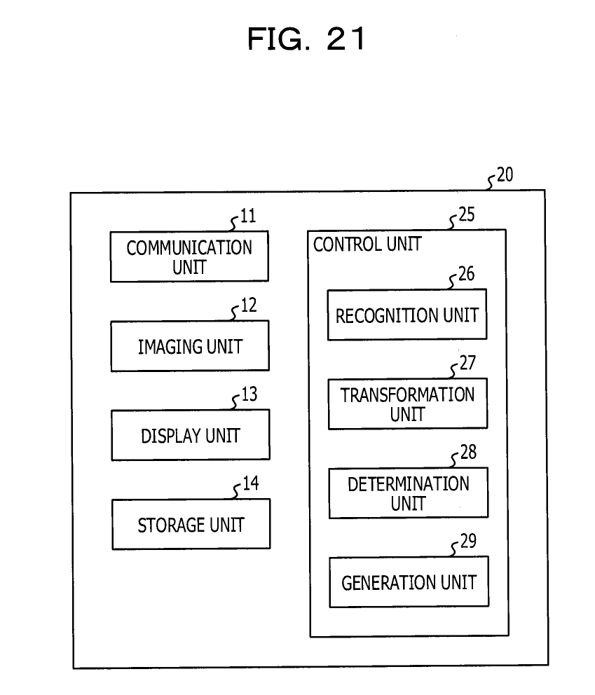

Hereinafter, a second embodiment will be described in detail. First, an example of the configuration of a system according to the second embodiment is the same as in the first embodiment illustrated in FIG. 9. Subsequently, the functional configuration of a display apparatus 20 according to the second embodiment will be described. FIG. 21 is a functional block diagram illustrating the display apparatus 20 according to the second embodiment. The display apparatus 20 includes a communication unit 11, an imaging unit 12, a display unit 13, a storage unit 14, and a control unit 25. The same reference numeral is attached to a processing unit, which performs the same process as each of the processing units of the display apparatus 10 according to the first embodiment, and the description thereof will not be repeated.

The control unit 25 controls the various processes of the whole display apparatus 20. The control unit 25 is caused to perform any one of an AR display process and an AR content rearrangement process selected by the user. In the embodiment, the AR display process is a process to superimposedly display AR content on input image data and to provide a notification when there is AR content which is not superimposedly displayable.

In contrast, the AR content rearrangement process is a process to virtually change the arrangement position and the size of a marker which is recognized from input image data and to redraw the AR content according to the arrangement position and the size of the changed marker. Further, the AR content rearrangement process is a process to generate AR content information based on the positional relationship between the AR content acquired after redrawing and an actual marker, and to update the AR content information stored in the storage unit 14 using the generated AR content information.

In the embodiment, the control unit 25 initially performs the AR display process, and starts the AR content rearrangement process when an instruction to start the AR content rearrangement process is input from the user. In this case, the AR content rearrangement process is performed based on the input image data from the imaging unit 12 at the time point in which the AR content rearrangement process starts.

In addition, the control unit 25 includes a recognition unit 26, a transformation unit 27, a determination unit 28, and a generation unit 29. In the AR display process, the recognition unit 26 performs the same process as in the first embodiment. For example, when it is determined that the image data input from the imaging unit 12 includes the image data of the marker, the recognition unit 26 generates area information indicative of the area of the marker in the input image data. In addition, the recognition unit 26 calculates the positional coordinates and the rotary coordinates of the marker based on the area information. Further, the recognition unit 26 acquires a marker ID which identifies the marker. The area information, the positional coordinates, the rotary coordinates, and the marker ID are output to the transformation unit 27.

In contrast, in the AR content rearrangement process, the recognition unit 26 calculates the positional coordinates and the rotary coordinates according to the virtually changed position and size of the marker based on the input from the user. The user virtually changes the position and size of the marker by performing a drag operation, a pinch-in operation, or a pinch-out operation on a touch panel. According to a method according to the related art, the amount of movement due to the drag operation performed by the user on the touch panel and an expanded or reduced size due to the pinch-in or pinch-out operation are expressed in numerical form, and are input to the recognition unit 26.

The recognition unit 26 changes the area information of the marker in the image data, which is input from the imaging unit 12, according to the input amount of the movement and the size of expansion and reduction. For example, the recognition unit 26 shifts the coordinates of four vertexes indicated by the area information in parallel according to the amount of movement. In addition, the recognition unit 26 enlarges or reduces the length of each of the sides, which are formed by the four vertexes indicated by the area information, according to the expanded or reduced size. Further, the recognition unit 26 calculates the positional coordinates and the rotary coordinates based on the changed area information.

In the embodiment, before the marker ID is transferred to the AR content rearrangement process, marker ID which is acquired in the AR display process is reused. However, in the AR rearrangement process, the recognition unit 26 may acquire the marker ID again. The changed area information, the positional coordinates, the rotary coordinates, and the marker ID are output to the transformation unit 27.

Subsequently, the transformation unit 27 generates the synthesized image data based on the input from the recognition unit 26, the AR content information, and the template information even in both the AR display process and the AR content rearrangement process similarly to the first embodiment. However, in the synthesized image data in the AR display process, the AR content is superimposedly displayed based on the marker which is recognized from the image data input from the imaging unit 12. In contrast, in the synthesized image data in the AR content rearrangement process, the AR content is superimposedly displayed based on the virtual marker based on the input performed by the user.

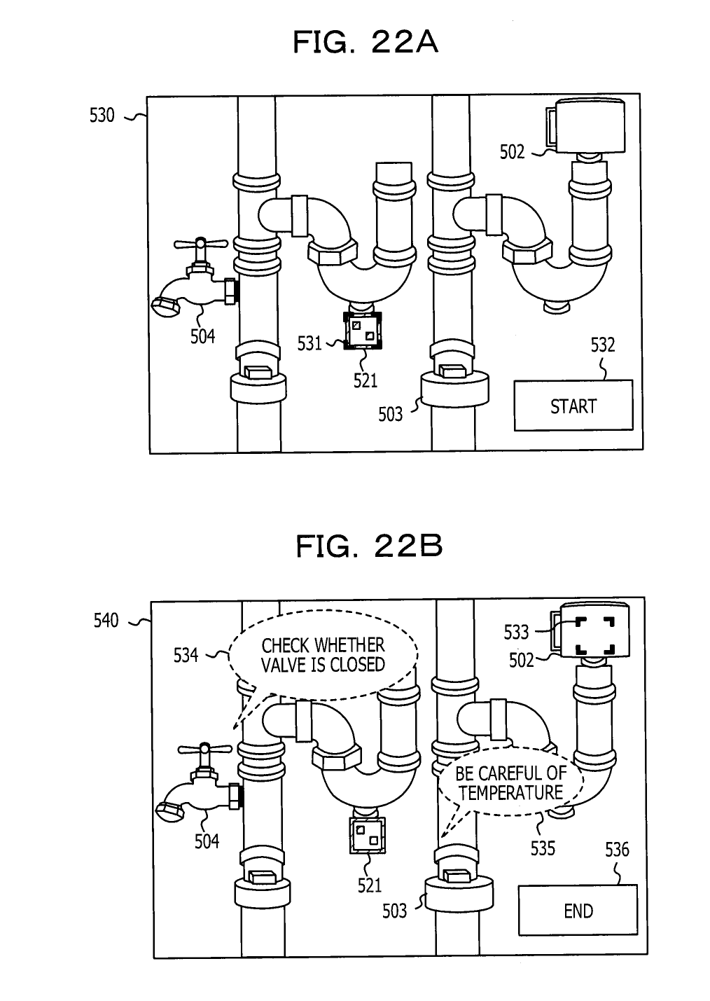

Here, FIGS. 22A and 22B illustrate the synthesized image data in the AR content rearrangement process. FIG. 22A illustrates a screen 530 on which the synthesized image data is displayed when the AR content rearrangement process starts. A superimposedly displayable part of the AR content 522 and the AR content 523 which are expressed in the synthesized image data 520 of FIG. 20B may be further displayed on the screen 530.

Image data photographed with a tank 502, a pipe 503, a valve 504, and a marker 521 is displayed on the screen 530. The tank 502, the pipe 503, the valve 504, and the marker 521 are the same as the tank 502, the pipe 503, the valve 504, and the marker 521 in FIG. 20B. Further, an input area 532 to input the start of the AR content rearrangement process is displayed on the screen 530.

When a pressing operation performed on the input area 532 is detected, a marker area operation frame 531 is displayed on the screen 530. The user performs the drag operation, the pinch-in operation, and the pinch-out operation on the frame 531. The input area 532 to input the start of the rearrangement process becomes an input area 536 to input the end of the rearrangement process as illustrated in FIG. 22B below after the pressing operation is performed.

FIG. 22B illustrates a screen 540 which displays the synthesized image data acquired when the user drags the marker area operation frame 531 on the tank 502. A marker area operation frame 533, which is transferred on the tank by the drag operation, is displayed on the screen 540 on which the synthesized image data is displayed. Further, when the recognition unit 26 virtually treats the frame 533 as the marker, AR content 534 and AR content 535 are superimposedly displayed based on the frame 533 by a process performed by the transformation unit 27. That is, a state, in which the AR content is superimposedly displayed when the marker 521 is stuck on the tank 502 by the user, is restored.

Further, when the user recognizes that the AR content 534 and the AR content 535 are arranged at positions which express an actual valve and a pipe, the user presses the input area 536 to input the end of the rearrangement process. If so, the generation unit 29 which will be described later, operates the positional information and the rotary information with regard to the marker 521 based on the arrangement of the AR content 534 and the AR content 535 with regard to the marker 521. Further, the generation unit 29 overwrites the positional information and the rotary information in the AR content information which is stored in the storage unit 14.

Returning to FIG. 21, the determination unit 28 determines whether or not the AR content is superimposedly displayable by comparing the image data of the AR content generated by the transformation unit 17 with the displayable range of the display unit 13 (display device), similarly to the first embodiment. In addition, a process performed by the determination unit 28 may be omitted. In addition, the determination unit 28 may perform only any one of the AR display process and the AR content rearrangement process.

In the AR display process, it is determined whether or not the AR content is superimposedly displayable at a predetermined position with regard to the marker which is recognized from the image data input from the imaging unit 12. In addition, in the AR content rearrangement process, it is determined whether or not the AR content is superimposedly displayable at the predetermined position with regard to the marker in which the position and the size are virtually changed.

The generation unit 29 generates the AR content information relevant to the rearranged AR content, and updates the AR content information stored in the storage unit 14. For example, the generation unit 29 generates the AR content information (the positional information and the rotary information) according to the positional relationship between the AR content, arranged based on the marker in which the position and the size are virtually changed, and the actual marker in the image data. The AR content information is generated based on the positional coordinates and the rotary coordinates, which are acquired from the actual marker, the coordinates (screen coordinate system) of the reference point of the AR content, and the inverse matrix of the transformation matrix T. A method according to the related art is applied to generate the AR content information using the inverse matrix of the transformation matrix.

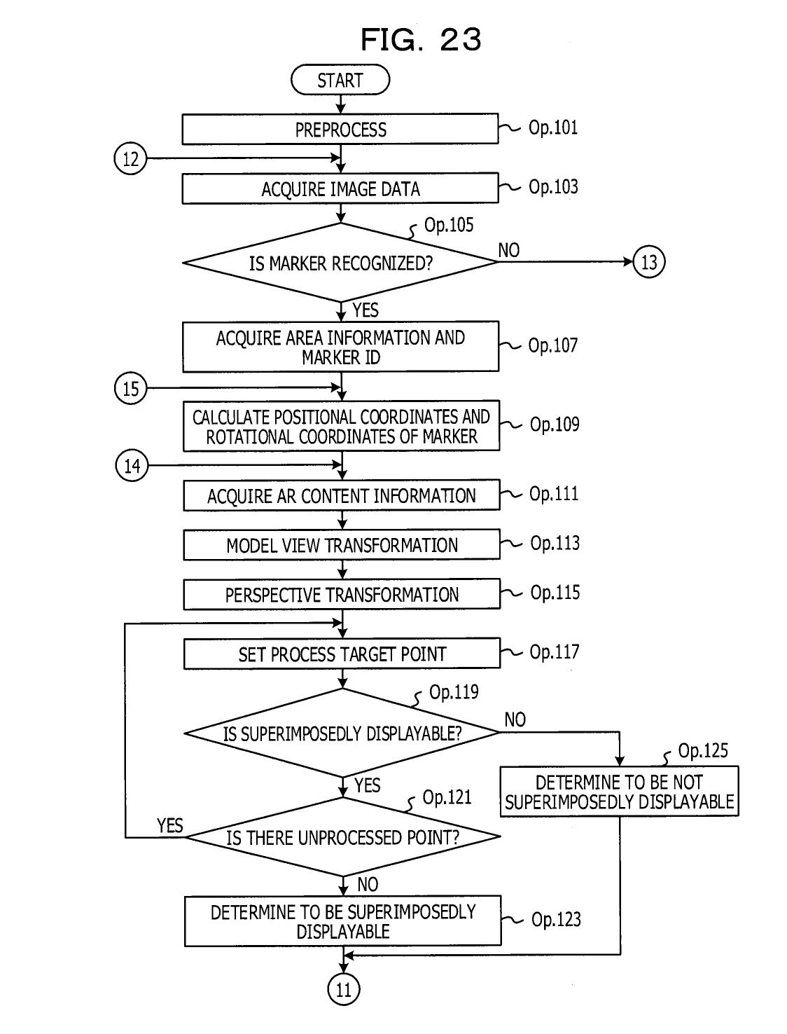

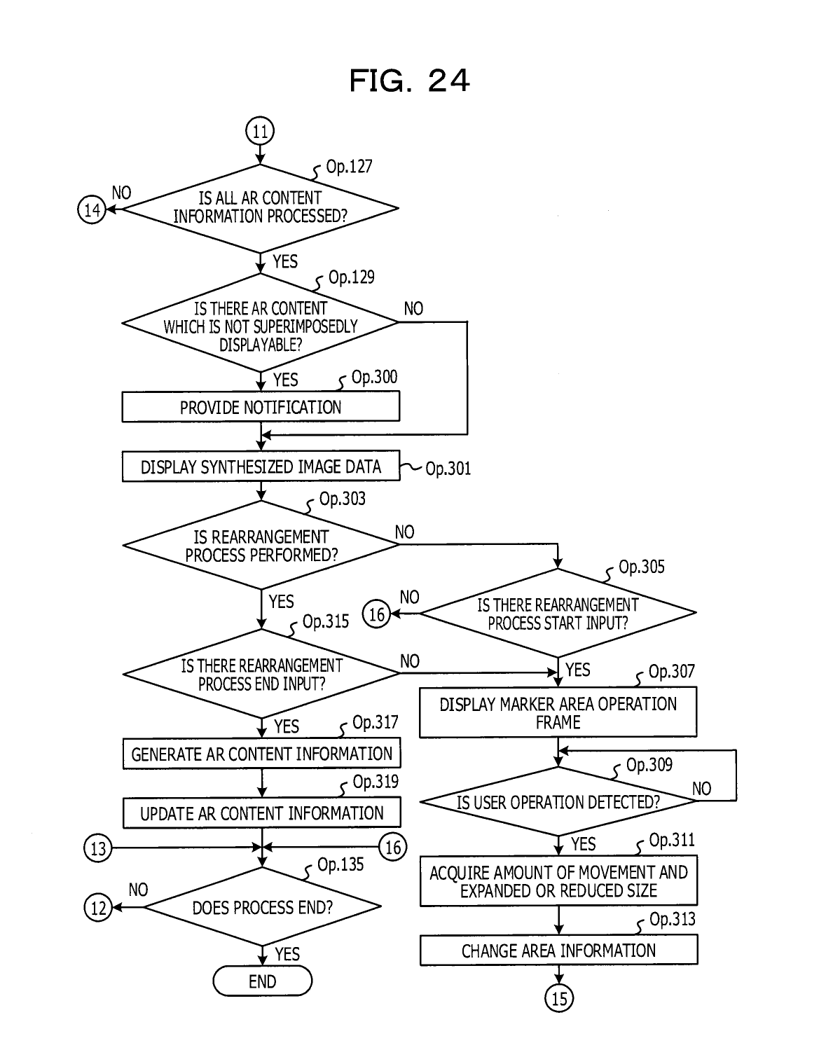

Subsequently, the flow of the display control process according to the second embodiment will be described. The display control process includes the AR display process and the AR content rearrangement process. FIGS. 23 and 24 are flowcharts illustrating the flow of the display control process according to the second embodiment. When a computer performs a display control program, a display control method is performed. In addition, the same reference numeral is attached to the process content which is the same as in the display control method according to the first embodiment, and the description thereof will not be omitted.

When display control program is driven, the control unit 25 performs a pre-process (Op. 101). In the embodiment, the AR display process is initially performed. Further, the control unit 25 performs the AR display process until the input of the start of the rearrangement process is received.

The recognition unit 26 acquires image data which is stored in a buffer provided in the storage unit 14 (Op. 103). Further, the recognition unit 26 performs the marker recognition on the acquired image data (Op. 105). When the marker is not recognized (No in Op. 105), the control unit 25 determines whether or not to end the display control process (Op. 135). When the display control process is ended (Yes in Op. 135), the control unit 25 ends a series of display control processes. In contrast, when the display control process is not ended (No in Op. 135), the control unit 25 repeatedly performs processes subsequent to Op. 103 on new image data.

In contrast, when the marker is recognized (Yes in Op. 105), the recognition unit 26 acquires the area information and reads the marker ID of the marker (Op. 107). The recognition unit 26 calculates the positional coordinates and the rotary coordinates of the marker in the camera coordinate system based on the form and the size of the figure of the marker in the image data (Op. 109). Further, the AR content information, which includes the marker ID acquired from the recognition unit 26, is acquired (Op. 111). Further, the corresponding template information is acquired using the data table which stores the template information based on the template ID which is included in the AR content information.

The transformation unit 27 generates the transformation matrix T using the positional coordinates and the rotary coordinates which are acquired from the recognition unit 26, and performs the model view transformation on each of the points, which are defined in the AR content information and the template information, using the transformation matrix T (Op. 113). Further, the transformation unit 27 transforms the coordinates of each of the points, which are expressed in the camera coordinate system, into the screen coordinate system (Op. 115). That is, perspective transformation is performed.

Subsequently, the determination unit 28 sets a process target point from among a plurality of points (screen coordinate system) which form the figure of the AR content (Op. 117). Further, the determination unit 28 determines whether or not a process target point is included in the displayable range of the display unit 13 (display device) (Op. 119).

When the part corresponding to the process target point of the AR content is superimposedly displayable (Yes in Op. 119), the determination unit 28 determines whether or not there is an unprocessed point (Op. 121). When there is an unprocessed point (Yes in Op. 121), the determination unit 28 newly sets a process target point (Op. 117). In contrast, when the AR content is not superimposedly displayable (No in Op. 119), the determination unit 28 determines that the AR content, which includes the process target point, is not superimposedly displayable (Op. 125).

In contrast, when there is no unprocessed point (No in Op. 121), that is, when it is determined that all the points are superimposedly displayable, the determination unit 28 determines that the AR content is superimposedly displayable (Op. 123). Subsequently, the determination unit 28 determines whether or not it is determined that it is superimposedly displayable with regard to all of the AR content information relevant to the marker ID (Op. 127). When there is unprocessed AR content information corresponding to the marker ID (No in Op. 127), the various processing units within the control unit 25 receive the output of the determination results acquired by the determination unit 28 and perform the processes after Op. 111.

In contrast, when all the AR content information is processed (Yes in Op. 127), the determination unit 28 determines the existence/non-existence of the AR content which is not superimposedly displayable (Op. 129). When there is the AR content which is not superimposedly displayable (Yes in Op. 129), the determination unit 26 provides notification that there is the AR content which is not superimposedly displayable (Op. 300). For example, the notification is provided using audio or display.

After the notification is provided or when there is no AR content which is not superimposedly displayable (No in Op. 129), the display unit 13 displays the synthesized image data under the control of the control unit 25 (Op. 301). That is, the control unit 25 displays the image data, which is acquired in Op. 103, and the synthesized image data, which includes the image data of the AR content generated by the transformation unit 27, on the display unit 13.

Further, when, for example, the AR display process is being performed, the input area 532 to input the start of the AR content rearrangement process is also displayed. In contrast, when the rearrangement process is being performed, the input area 536 to input the end of the AR content rearrangement process is also displayed. When the notification is provided using display in Op. 300, a message, which provides notification that there is the AR content which is not superimposedly displayable, may be displayed in the synthesized image data displayed in Op. 301.

Subsequently, the control unit 25 determines whether or not the rearrangement process is currently being performed (Op. 303). In the embodiment, although the AR display process is initially performed, it is determined whether or not the process is already replaced by the rearrangement process based on the input performed by the user.

When the rearrangement process is not being performed (No in Op. 303), the control unit 25 determines whether or not the rearrangement process start input is received (Op. 305). For example, when the synthesized image data is displayed on the screen in Op. 301, the user presses the input area 532 if the user desires the start of the rearrangement process. According to this, the control unit 25 determines that the rearrangement process start input is received.

When the rearrangement process start input is received (Yes in Op. 305), the display unit 13 displays the marker area operation frame in the synthesized image data, which is displayed in Op. 301, under the control of the control unit 25 (Op. 307). When a process in Op. 307 is performed after it is determined that there is the rearrangement process start input in Op. 305, the marker area operation frame corresponds to an area in which an actual marker is photographed. That is, the control unit 25 displays the marker area operation frame using the area information which is acquired by the recognition unit 26 in Op. 107.

Subsequently, the control unit 25 determines whether or not an operation performed on the marker area operation frame by the user is detected (Op. 309). An operation, which is a detection target, includes, for example, the drag operation, the pinch-in operation, and the pinch-out operation.

When the operation performed by the user is not detected (No in Op. 309), the control unit 25 waits until the operation is detected. Further, when any one of the drag operation, the pinch-in operation, and the pinch-out operation performed by the user is detected (Yes in Op. 309), the recognition unit 26 acquires the amount of movement due to the drag operation or the expanded or reduced size due to the pinch-in operation or the pinch-out operation (Op. 311). Further, the recognition unit 26 changes the area information of the marker according to the amount of movement or the expanded or reduced size (Op. 313). Further, the recognition unit 26 repeats the processes after Op. 109 using the changed area information.

In contrast, when the rearrangement process is already being performed (Yes in Op. 303), the control unit 25 determines whether or not there is the rearrangement process end input (Op. 315). For example, when the synthesized image data is displayed on the screen in Op. 301, the user presses the input area 536 if the user desires to end the rearrangement process. According to this, the control unit 25 determines that the rearrangement process end input is received.

When there is no rearrangement process end input (No in Op. 315), that is, when the rearrangement process is continued, the control unit 25 performs processes after Op. 307. When the rearrangement process is continued, the process in Op. 313 was performed in the past. Therefore, the marker area operation frame which is displayed according to the area information indicates the virtual marker acquired after the user performs the drag operation, the pinch-in operation, and the pinch-out operation.

Accordingly, the user recognizes the arrangement of the AR content which is superimposedly displayed according to the virtual marker after the user once performs some kind of operation. Further, the user can adjust the arrangement position of the AR content again by performing an operation on the marker area operation frame.

In Op. 315, when there is the rearrangement process end input (Yes in Op. 315), the generation unit 29 generates the AR content information (Op. 317). The positional information and the rotary information of the AR content information are generated. Further, the generation unit 29 updates the AR content information stored in the storage unit 14 using the newly generated AR content information (Op. 319).

For example, the generation unit 29 searches the storage unit 14 based on the content ID which is included in the AR content information acquired in Op. 111. Further, the generation unit 29 updates the positional information and the rotary information of the found AR content information using the newly generated positional information and the rotary information. Further, the control unit 25 determines whether or not the process ends (Op. 135). When there is an input having a gist of the end of the process (Yes in Op. 135), a series of display control processes end.

As described above, the display apparatus 20 is able to reduce the load to rearrange the AR content which is desired in accordance with the change or the like of the position on which the marker is stuck. In addition, when a plurality of pieces of AR content is associated with a single marker, it is possible to rearrange the plurality of pieces of AR content at once by moving, enlarging, or reducing the frame of the marker operation area.

In particular, when the position on which only the marker is stuck is changed and the positions of apparatuses or facilities which are related to the content of the AR content are not changed, a burden on the user is reduced compared to a case in which each of the positions of the AR content is reconfigured from the beginning.

In the flowcharts, the display apparatus 20 causes the amount of movement and the expanded or reduced size according to the operation performed by the user to be reflected to the area information, and calculates the positional coordinates and the rotary coordinates of the marker again. Further, the display apparatus 20 performs an AR content coordinate transformation process based on the new positional coordinates and the rotary coordinates.

However, as another method, the display apparatus 20 may reflect the amount of movement and the expanded or reduced size according to the operation performed by the user to already calculated values of the AR content in the screen coordinate system. That is, the display apparatus 20 determines the position of the AR content to be superimposedly displayed according to the virtual marker by shifting the AR content in parallel or by expanding or reducing the AR content. Further, display is performed as on the screen 540.

Example of Hardware Configuration

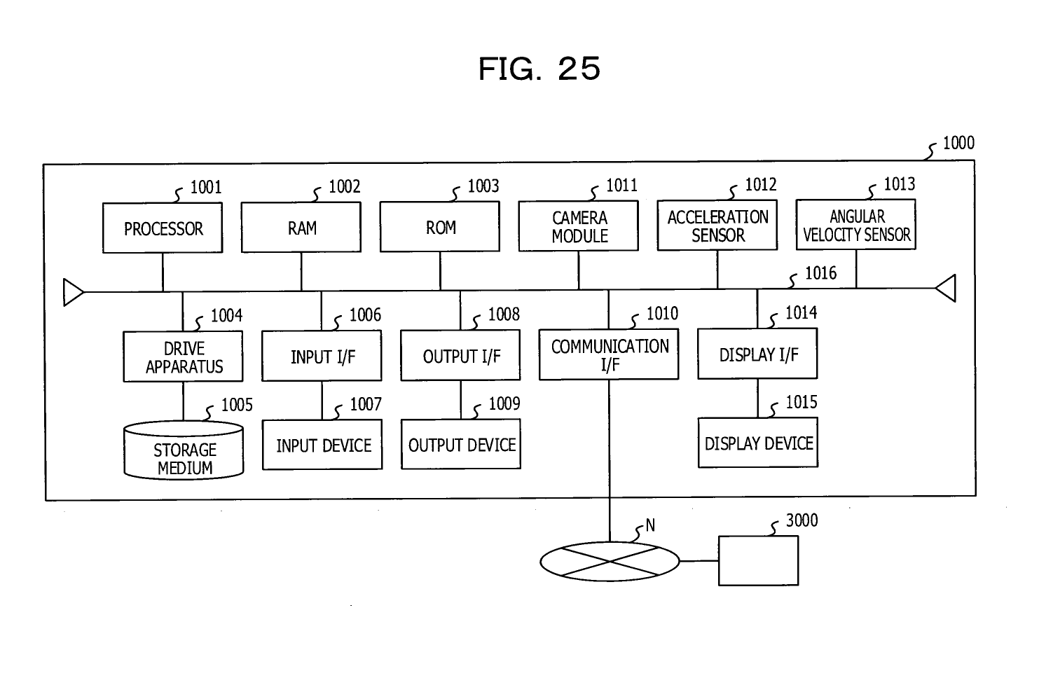

The hardware configuration of the display apparatus 1 and the management apparatus 3 according to each embodiment will be described. FIG. 25 illustrates an example of the hardware configuration of the display apparatus according to each embodiment. The display apparatus 1 (the display apparatus 10 or the display apparatus 20) according to each embodiment is realized by a computer 1000. The functional blocks illustrated in FIGS. 11 and 21 are realized by, for example, the hardware configuration illustrated in FIG. 25. The computer 1000 includes, for example, a processor 1001, a random access memory (RAM) 1002, a read only memory (ROM) 1003, a drive apparatus 1004, a storage medium 1005, an input interface (input I/F) 1006, an input device 1007, an output interface (output I/F) 1008, an output device 1009, a communication interface (communication I/F) 1010, a camera module 1011, an acceleration sensor 1012, an angular velocity sensor 1013, a display interface (display I/F) 1014, a display device 1015, a bus 1016, and the like. The respective hardware are connected through the bus 1016.

The communication interface 1010 controls communication through a network N. The communication controlled by the communication interface 1010 may be a form in which the network N is accessed through a wireless base station using wireless communication. An example of the communication interface 1010 is a Network Interface Card (NIC). The input interface 1006 is connected to the input device 1007, and transmits an input signal, which is received from the input device 1007, to the processor 1001. The output interface 1008 is connected to the output device 1009, and causes the output device 1009 to perform output according to an instruction from the processor 1001. An example of the input interface 1006 and the output interface 1008 is an I/O controller.

The input device 1007 is an apparatus which transmits the input signal according to an operation. The input signal is, for example, a key apparatus, such as a keyboard or a button attached to the main body of the computer 1000, or a pointing device such as a mouse or a touch panel. The output device 1009 is an apparatus which outputs information according to the control of the processor 1001. The output device 1009 is, for example, an audio output apparatus such as a speaker.

The display interface 1014 is connected to the display device 1015. The display interface 1014 displays image information, which is written in a display buffer provided in the display interface 1014 by the processor 1001, on the display device 1015. An example of the display interface 1014 is a graphics card or a graphics chip. The display device 1015 is an apparatus which outputs information according to the control of the processor 1001. An image output apparatus, such as a display device, a transmission type display device, or the like is used as the display device 1015.

When the transmission type display device is used, control may be performed such that the projection image of the AR content is displayed, for example, at an appropriate position within the transmission type display device without being synthesized with the imaged image. Therefore, the user may visually recognize a state in which the real space is matched with the AR content. In addition, for example, an input/output apparatus, such as a touch screen, is used as the input device 1007 and the display device 1015. In addition, for example, the input device 1007 and the display device 1015 may be connected from the outside of the computer 1000 instead of the input device 1007 and the display device 1015 being embedded inside the computer 1000.

The RAM 1002 is a memory apparatus which is able to be read and written. For example, a semiconductor memory, such as a static RAM (SRAM) or a dynamic RAM (DRAM), a flash memory, or the like may be used in addition to the RAM. The ROM 1003 includes a programmable ROM (PROM) or the like.

The drive apparatus 1004 is an apparatus which performs at least one of reading and writing of information stored in the storage medium 1005. The storage medium 1005 stores information which is written by the drive apparatus 1004. The storage medium 1005 is, for example, at least one of some kinds of storage media such as a hard disk, a solid state drive (SSD), a compact disc (CD), a digital versatile disc (DVD), and a Blu-ray Disc. In addition, for example, the computer 1000 includes a drive apparatus 1004 corresponding to the kind of the storage medium 1005 within the computer 1000.

The camera module 1011 includes an imaging element (image sensor), and writes data, acquired through photoelectric transformation performed by the imaging element, onto an image buffer for the input image, which is included in the camera module 1011. The acceleration sensor 1012 measures acceleration acting on the acceleration sensor 1012. The angular velocity sensor 1013 measures an angular velocity of an operation performed by the angular velocity sensor 1013.

The processor 1001 reads out a program, stored in the ROM 1003 or the storage medium 1005, to the RAM 1002, and performs a process according to the procedure of the read program. For example, the function of the control unit 15 is realized in such a way that the processor 1001 controls another hardware based on the display control program in which the process illustrated in FIGS. 15 to 17 is stipulated. In addition, for example, the function of the control unit 25 is realized in such a way that the processor 1001 controls another hardware based on the display control program in which a process is stipulated in FIGS. 23 and 24.

The function of the communication unit 11 is realized in such a way that the processor 1001 performs data communication by controlling the communication interface 1010, and stores the received data in the storage medium 1005. The function of the imaging unit 12 is realized in such a way that the camera module 1011 writes the image data onto the image buffer for the input image, and the processor 1001 reads the image data within the image buffer for the input image. The image data is written into, for example, the image buffer for the input image in a monitoring mode, and written into the display buffer of the display device 1015 in parallel.

In addition, the function of the display unit 13 is realized in such a way that the image data generated by the processor 1001 is written into the display buffer provided for the display interface 1014, and the display device 1015 displays the image data within the display buffer. The function of the storage unit 14 is realized in such a way that the ROM 1003 and the storage medium 1005 store a program file and a data file, and the RAM 1002 is used as the work area of the processor 1001. For example, the AR content information, the template information, and the like are stored in the RAM 1002.

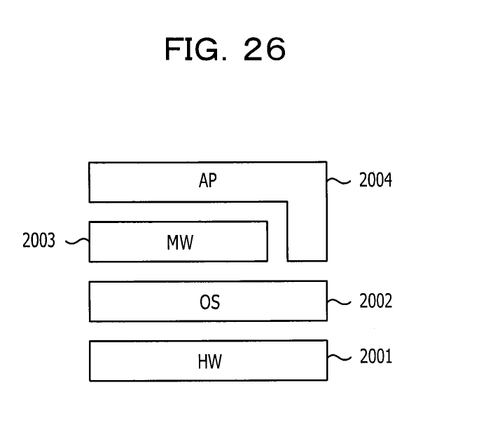

Subsequently, FIG. 26 illustrates a configuration example of a program which operates in the computer 1000. An operating system (OS) 2002, which controls a hardware group, operates in the computer 1000. When the processor 1001 operates in order according to the OS 2002 and hardware (HW) 2001 is controlled and managed, a process according to an application program (AP) 2004 or middleware (MW) 2003 is performed on the HW 2001.

In the computer 1000, the programs of the OS 2002, the MW 2003, the AP 2004, and the like are executed, for example, after being read into the RAM 1002 by the processor 1001. In addition, the display control program described in each embodiment is, for example, a program which is called from the AP 2004 as the MW 2003.

In addition, for example, the display control program is a program which realizes the AR function as the AP 2004. The display control program is stored in the storage medium 1005. The storage medium 1005 may be distributed after being separated from the main body of the computer 1000 in a state in which the single display control program according to the embodiment or an AR control program, which includes another program, are stored.

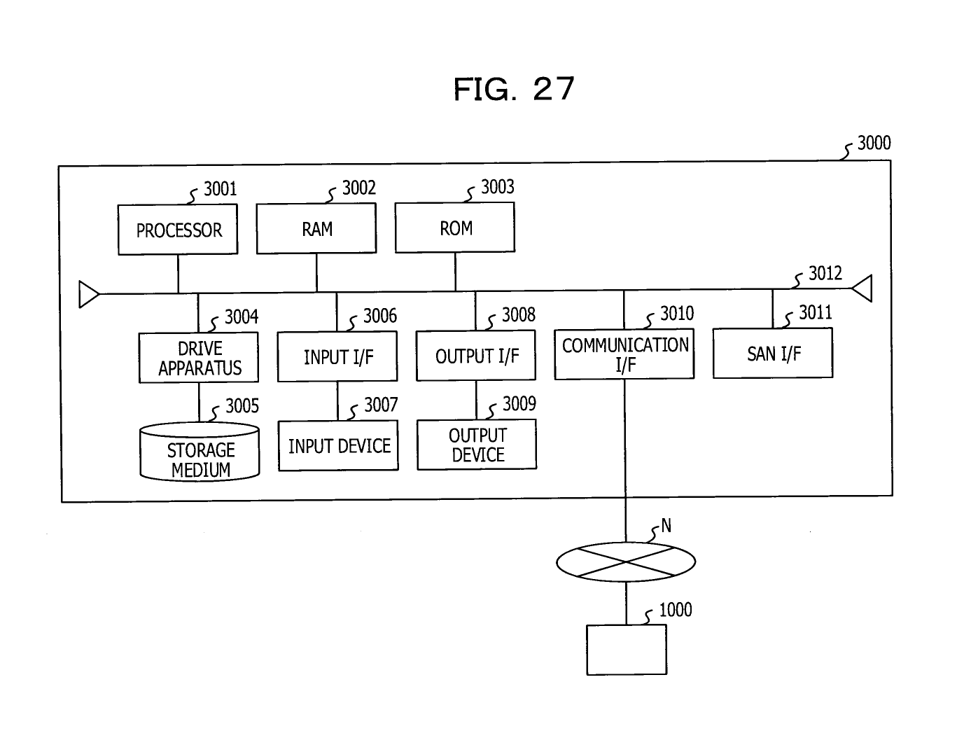

Subsequently, the hardware configuration of the management apparatus 3 according to each embodiment will be described. FIG. 27 illustrates an example of the hardware configuration of the management apparatus 3. The management apparatus 3 is realized by a computer 3000. The management apparatus 3 is realized by, for example, the hardware configuration illustrated in FIG. 27.

The computer 3000 includes, for example, a processor 3001, a RAM 3002, a ROM 3003, a drive apparatus 3004, a storage medium 3005, an input interface (input I/F) 3006, an input device 3007, an output interface (output I/F) 3008, an output device 3009, a communication interface (communication I/F) 3010, a storage area network (SAN) interface (SAN I/F) 3011, a bus 3012, and the like. The respective hardwares are connected to each other through the bus 3012.

For example, the processor 3001 is a hardware which is the same as the processor 1001. The RAM 3002 is a hardware which is the same as, for example, the RAM 1002. The ROM 3003 is a hardware which is the same as, for example, the ROM 1003. The drive apparatus 3004 is a hardware which is the same as, for example, the drive apparatus 1004. The storage medium 3005 is a hardware which is the same as, for example, the storage medium 1005. The input interface (input I/F) 3006 is a hardware which is the same as, for example, the input interface 1006. The input device 3007 is a hardware which is the same as, for example, the input device 1007.

The output interface (output I/F) 3008 is a hardware which is the same as, for example, the output interface 1008. The output device 3009 is a hardware which is the same as, for example, the output device 1009. The communication interface (communication I/F) 3010 is a hardware which is the same as, for example, the communication interface 1010. The storage area network (SAN) interface (SAN I/F) 3011 is an interface to cause, for example, the computer 3000 to be connected to the SAN, and includes a host bus adapter (HBA).

The processor 3001 reads out a management program, stored in the ROM 3003 or the storage medium 3005, to the RAM 3002, and performs a process according to the procedure of the read management program. At this time, the RAM 3002 is used as the work area of the processor 3001. The management program is a program according to the management function of the management apparatus 3, and includes a display control program according to each embodiment when display control is performed on the side of the management apparatus 3.

When the ROM 3003 and the storage medium 3005 store the program file and the data file or when the RAM 3002 is used as the work area of the processor 3001, the management apparatus 3 stores various pieces of information. In addition, the processor 3001 performs a communication process by controlling the communication interface 3010.

### Modified Example

In another form of the disclosed embodiment, the projection image of the AR content C may be displayed on the transmission type display device. Even in this form, the figure in the real space, which is acquired through the display device, is matched with the projection image of the AR content, and thus visual information supplied to the user is expanded.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A system comprising:
circuitry configured to:
acquire image data captured by an electronic device,
acquire content and display position information corresponding to the content based on an object detected in the image data, the display position information indicating a display position of the content in relation to the object,
determine whether the content is capable of being displayed by a display in a superimposed manner on the image data at the display position,
generate guide information indicating at least one of a recommended size and a recommended position of the object in relation to the display based on at least one of a position and a size of the object in the image data when it is determined that the content is not capable of being displayed, and
output the guide information.

2. The system according to claim 1, wherein the guide information indicates at least one of the recommended size and the recommended position of the object to be captured in subsequent image data.

3. The system according to claim 2, wherein the circuitry is configured to:
reduce an area of the object in the image data by a prescribed reduction ratio when it is determined that the content is not capable of being displayed,
determine whether the content is capable of being displayed after the reduction, and
generate the guide information indicative of the reduced area when it is determined that the content is capable of being displayed.

4. The system according to claim 3, wherein the circuitry is configured to repeat a process of reducing the area until it is determined that the content is capable of being displayed.

5. The system according to claim 1, wherein the circuitry is configured to determine a positional relationship between the object and the electronic device based on the object detected in the image data.

6. The system according to claim 5, wherein the circuitry is configured to identify the display position of the content based on the positional relationship and the display position information.

7. The system according to claim 6, wherein the circuitry is configured to determine whether the content is capable of being displayed based on the display position of the content and a display range of the display.

8. The system according to claim 1, wherein the display position information is set based on a unit amount corresponding to a size of the object detected in the image data.

9. The system according to claim 8, wherein the circuitry is configured to transform a displayable range of the display to another displayable range based on the unit amount and the size of the object detected in the image data.

10. The system according to claim 9, wherein the circuitry is configured to determine whether the content is capable of being displayed based on the display position and the another displayable range.

11. The system according to claim 1, wherein the content includes information indicating a task to be performed corresponding to the object detected in the image data.

12. The system according to claim 1, wherein the object detected in the image data is a marker having at least one of a specific shape or pattern.

13. The system according to claim 1, further comprising:
the electronic device, and
wherein the electronic device includes:
an image pickup device configured to capture the image data; and
a communication interface configured to send the image data to the system via a network and receive the guide information from the system via the network.

14. The system according to claim 1, further comprising:
the electronic device, and
wherein the electronic device includes a display configured to display at least one of the content, the image data and the guide information.

15. The system according to claim 1, wherein the system is a server.

16. The system according to claim 15, wherein the server includes:
the circuitry; and
a communication interface configured to receive the image data from the electronic device via a network and transmit the guide information to the electronic device via the network.

17. A non-transitory computer-readable medium including computer program, which when executed by a system, causes the system to:
acquire image data captured by an electronic device,
acquire content and display position information corresponding to the content based on an object detected in the image data, the display position information indicating a display position of the content in relation to the object,
determine whether the content is capable of being displayed by a display in a superimposed manner on the image data at the display position,
generate guide information indicating at least one of a recommended size and a recommended position of the object in relation to the display based on at least one of a position and a size of the object in the image data when it is determined that the content is not capable of being displayed, and
output the guide information.

18. The non-transitory computer-readable medium according to claim 17, wherein the guide information indicates at least one of the recommended size and the recommended position of the object to be captured in subsequent image data.

19. A display control method performed by an information processing system, the method comprising:
acquiring image data captured by an electronic device;
acquiring content and display position information corresponding to the content based on an object detected in the image data, the display position information indicating a display position of the content in relation to the object;
determining whether the content is capable of being displayed by a display in a superimposed manner on the image data at the display position;
generating, by circuitry of the information processing system, guide information indicating at least one of a recommended size and a recommended position of the object in relation to the display based on at least one of a position and a size of the object in the image data when it is determined that the content is not capable of being displayed; and
outputting the guide information.

20. The display control method according to claim 19, wherein the guide information indicates at least one of the recommended size and the recommended position of the object to be captured in subsequent image data.
